(19) United States
(12) Patent Application Publication
(10) Pub. No.: US 2024/0249297 A1
(43) Pub. Date: Jul. 25, 2024

(54) METHOD AND SYSTEM FOR WEB-BASED MANAGEMENT OF CONSUMER PACKAGED GOODS

(71) Applicant: OnePage Software, LLC, Lusby, MD (US)

(72) Inventors: Miles Dickinson, Washington, DC (US); Ryan Moore, Baltimore, MD (US)

(21) Appl. No.: 18/420,650

(22) Filed: Jan. 23, 2024

Related U.S. Application Data
(60) Provisional application No. 63/481,330, filed on Jan. 24, 2023.

(51) Int. Cl. G06Q 30/0202; G06Q 10/08; G06Q 30/0207

(52) U.S. Cl. CPC G06Q 30/0202; G06Q 10/08; G06Q 30/0207

(57) ABSTRACT

Methods and systems for web-based management of consumer packaged goods (CPG). In an exemplary method, the management can be implemented at one or more nodes of supplying a product. A computing system can receive at least one input parameter associated with a first selected node of the nodes, and a request to generate a forecast for at least one output parameter based upon the input parameter. The computing system can generate the forecast based upon a database storing data of the nodes and upon implementing a model with the data and the input parameter. The method offers an integrated solution allowing all departments managing the CPG to leverage data to inform their specific use-cases. The bottom-up architecture ties customer DCs to retailers, and ties customer DCs to manufacturer DCs, allowing an integrated approach aligning the needs across all departments to a single system, resulting in a holistically better forecast.

### CROSS-REFERENCE TO RELATED APPLICATIONS

This application claims priority to U.S. Provisional Patent Application Ser. No. 63/481,330, filed on Jan. 24, 2023. Priority to the provisional patent application is expressly claimed, and the disclosure of the provisional application is hereby incorporated herein by reference in its entirety and for all purposes.

### FIELD

The disclosed embodiments relate generally to cross-functional computing platforms and more particularly, but not exclusively, to methods and systems for electronic management of consumer packaged goods (CPG).

### BACKGROUND

CPG are items used daily by average consumers that require routine replacement or replenishment, such as food, beverages, clothes, tobacco, makeup, household products. Even though computing technologies and web-applications have had significant advancement over the past two decades, there is still an absence of a cloud-based, integrated business planning application for growing CPG brands. Such an absence has led to fragmented planning processes, resulting in poor sales, supply chain, and financial performance.

In one example, according to the current state of demand planning, there are two principal methodologies used by organizations to plan demand for their products, including “bottom-up” and “top-down” methodologies. While established brands with national distribution may use a top-down methodology, new and growing brands must use bottom-up planning.

The top-down methodology employs statistical modeling of demand from year-over-year trends. The goal is to arrive at a top-line (or gross sales) number for the entire brand, then “disaggregate” that forecast to lower levels of abstraction in the supply chain. These “disaggregations” are driven by statistical or other multivariate mathematical models.

Constraints of the top-down methodology vary. For growing brands, the top-down methodology cannot be used to model demand given that these brands lack the consistent data that makes top-down possible. Since new brands are typically both growing in normal sales at existing retailers and expanding their distribution at new retailers, which themselves do not have the requisite history to have reliable statistical models, examining history to project future sales is futile.

On the other hand, constraints of the bottom-up methodology are as following. The granularity of the bottom-up plan is typically a major hurdle to manage for a brand since it relies on maintaining a significant number of variables that are sourced from different teams within the brand. Conventionally, the accepted methodology of planning is creating a mathematical model in an unwieldy spreadsheet. Often, different departments would maintain their models in different spreadsheets, modeling roughly the same data, without harmonization. The inventors of the present disclosure have discovered that, in accordance with existing systems and methods, the models maintained by different departments rely on essentially the same sell-through data to project sales, but apply that data in different ways and/or different systems depending on the context. In accordance with the disclosure set forth herein, the system and method can ensure that all of the data inputs for the models can be harmonized such that a change in the data set can affect all of the subsequent metric calculations.

In another example, according to the current state of trade promotion management, many, if not all, trade promotion management systems eschew integrating a forecast by customer distribution center (DC) because the trade promotion management systems focus solely on the retailer and promotion plans at said retailer. The reason for such a focus is that trade promotion management systems are marketed solely to sales leaders in CPG organizations. Such sales leaders have neither the bandwidth nor the incentive to manage at the customer DC level, leaving the operations team to develop a supply chain map offline, or with no connection with the trade promotion management systems. In conventional trade promotion systems, there is a calendarized view of the promotion plan by retailer. However, the trade plan ignores the supply chain through which the retailers are supplied. When it comes to integrating with the demand plan needs, there may be an ad hoc linkage between systems. However, the inventors of the present disclosure have discovered that,

In yet another example, according to the current state of customer order validation, many brands receive orders via email and electronic data interchange (EDI) for each of their “ship-to's,” or customer distribution centers. From there, the order can be parsed into an order management system (OMS) or in some cases a spreadsheet. The orders can then be communicated to logistics partners to pick, stage, and ship to the customer per the order. In the current state, orders are often not validated whatsoever for their conformance against the forecast, and brands opt to ship orders in full regardless. This leaves the brand exposed to significant upstream and downstream supply chain risk. There can be great risks associated with over-orders and under-orders as following.

A customer, whether that is a direct retailer or an indirect distributor, may from time-to-time over order significantly. There are several root causes of that over-ordering: poor master data in buying systems; errors in the transmission of the order; or customers wanting to take advantage of favorable pricing. In the case of an error in data or sending the order, the customer will be significantly overstocked, causing them to fail to reorder in their normal cadence. This has implications in the cashflow projections of an emerging brand. For both perishable and non-perishable brands, overordering can be significantly expensive as spoilage expenses in customer warehouses and on retail shelves is often passed through to the manufacturer to cover in full, with an additional upcharge. For perishable brands, this spoilage rate can often be anywhere from 5%-15% of gross sales. In the case of customers ordering to take advantage of favorable pricing, this can over encumber the trade promotion budget of a brand or impact the gross sales forecast in the case of a price increase. For example, if a price increase is communicated to a distributor, that distributor will buy as much as possible ahead of the price increase going into effect to maximize their margins. This can be an intensely disruptive practice when it comes to cash flow projection and inventory working capital management. Situations occur in which distributor over-orders are filled in full, which subsequently causes the brand to short “legitimate” orders to customers that need the product.

Under-ordering can be just as detrimental to a brand as over-orders, if not more so. Without product on shelf, meeting demand, an emerging brand's sales can be perceived as weak by those managing the product assortments at the retailers, potentially leading to discontinuation—terrible news for any brand seeking to gain market share. Like over-ordering, under-ordering can happen for a myriad of causes, such as poor retail buying system assumptions, or the customer's desire to keep their working capital low.

Brands that do validate their orders often do so in offline Excel files, comparing the order vs. the forecast. The inventors of the present disclosure have discovered that the brand does not maintain a true “days of coverage” projection of their customers' warehouses directly informed by the forecast.

In view of the foregoing, there is a need for an improved system and method for a cross-functional computing platform for managing CPG that overcomes the drawbacks of existing solutions.

### BRIEF DESCRIPTION OF THE DRAWINGS

FIG. 1 is a schematic diagram illustrating exemplary functions of an organization associated with a CPG brand.

FIG. 2 is a diagram illustrating an exemplary method for demand planning of the functions of FIG. 1.

FIG. 3 is a diagram illustrating exemplary entities associated with master data regarding supply chain and promotions.

FIG. 4 is a diagram illustrating an exemplary distribution point forecast interface.

FIG. 5 is a diagram illustrating an exemplary interface of a promotion calendar at an exemplary retailer.

FIG. 6 is a diagram illustrating exemplary data streams that can be ingested.

FIG. 7 is a diagram illustrating an exemplary interface of an exemplary scenario planner.

FIG. 8 is a diagram illustrating an exemplary embodiment of a system for implementing the functions of FIG. 1.

FIG. 9 is an exemplary diagram illustrating an embodiment of an operation environment for managing CPG in accordance with various embodiments.

FIG. 10 is an exemplary top-level flow chart illustrating an embodiment of a method for managing CPG in accordance with various embodiments.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

The method as set forth in the present disclosure can be implemented via a web-application that seamlessly and uniquely combines elements of bottom-up demand planning, trade promotion management, customer order validation, and supply planning into one cohesive cross-functional platform. Whereas current solutions on the market largely cater to growing brands using statistical modeling on massive historical datasets. The disclosed method aims to be implemented for all brands from pre-revenue to the hundreds of millions in gross revenue.

The central operational thesis of the disclosed method is that if organizational silos are removed and incentives are aligned between sales and operations, forecasting and executional performance can be maximized. For example, sales (or sales management system or personnel) can use the disclosed method to accurately predict gross sales and promotional budgets to meet their targets. Similarly, operations can ensure that a system implemented the disclosed method is accurate to secure production capacity and orders are in right-sized. The disclosed method can calculate a base forecast, which includes metrics for a particular day, a product sold at a retailer store, supplied by a customer distribution center. The method applies attributes from the retailer, product, customer DC to the base forecast, which gives all the necessary data to calculate gross sales and other trade metrics. The method can take the calculated base forecast, and iterate over each point to determine the gross sales for each point illustrated in the exemplary code below:

```
let grossSales = 0
if (basePoint.listPrice !== null) {
  grossSales = (totalCases * basePoint.listPrice)
} else if (basePoint.productGroupConfigCaseCost !== null) {
  grossSales = (totalCases * basePoint.productGroupConfigCaseCost)
} else if (basePoint.productGroupCaseCost !== null) {
  grossSales = (totalCases * basePoint.productGroupCaseCost)
}
basePoint.grossSales = grossSales
```

The gross sales can be determined by the active forecasts for the point in time. If there are any list prices at the distribution point level, the list prices at the distribution point level can be used. Otherwise, if there is an active retailer product group case cost, the active retailer product group case cost can be used. If neither the list prices at the distribution point level nor the active retailer product group case cost is available, the case cost on the containing product group can be used.

In existing CPG environments, sales planning is a separate discipline from the demand planning process given that those departments plan on different levels of the business. For example, the sales planning is concerned with their retail sales, promotional lift, and trade promotion strategy. Operations Planning is concerned with demand planning case shipment volume from inbound warehouses to outbound warehouses. These are separate disciplines for manifold reasons that the disclosed method can reconcile:
1. The distribution network is too complex to model from the bottom-up.
2. The differences in timing and order magnitude between the on-shelf date of a promotion and when that delivery is needed is ill defined.
3. The brand is at such a scale where retailer-level programs are insubstantial in the broader context of the brands performance.

Beyond the disparate nature of volume planning, demand planning and trade promotion management, feature sets are wholly different. For example, demand planning systems are informed by prior shipment history to create a multivariate statistical model while trade promotion management tools incorporate promotional contract terms, scenario planning, and rates of sale management.

Growing brands cannot use statistical modeling at their scale, given the fact their volume is much more proportionally influenced than more mature brands. Additionally, because they are growing, the need to anticipate step changes in demand with new retailers accepting their products and consumer knowledge of their brand is increasing. These growing brands come to rely on a “bottom-up build” in which the rates of sale are planned at the retailer, which gives rise to the operational demand plan. This presents an opportunity for the disclose method's provision of cross-functional insights for both sales and operations. With the integrated approach of the disclose method, sales can plan a [al tactic, such as a “buy-one-get-one” deal, understand the total spend of the promotion through inputting the spend per unit or a fixed amount, understand the impacts to the gross sales of the brand, while having that forecast feed directly into the demand plan for operations to feed the supply and production planning.

The overarching goal of the disclosed method is to create an application that spans a brand's entire go-to-market organization from raw-material procurement to promotion planning using one source of truth. The computing platform implementing the disclosed method is unique in its ambition, architecture, and approach.

The goal of the disclosed method is to give growing brands a granular, yet scalable cloud-based infrastructure from which they can integrate sales planning, supply chain planning, and financial planning. By uniquely aligning interests, and therefore behaviors, across departments, the inputs more accurately reflect the latest thinking of the business.

For example, in conventionally methods or systems trade promotion plans do not directly and visibly impact the demand plan at both the retailer and upstream supply chain nodes. In contrast, the disclosed method uses the distribution points (the presence of products at a retailer store, and the customer distribution center that ships to the retailer store) to determine which proportion of data should be allocated to a respective distribution point when aggregating up to the retailer level. For example, sales orders can be equal to cases of product delivered to a customer distribution center, and the disclosed method can use the current proportionality of retailer stores receiving product from that distribution center to determine which sales order cases should be assigned to a retailer. Additionally, scan data are units of product purchased from a retailer store, where the current proportionality of distribution centers supplying that retailer store can determine which scan units should be allocated to a customer distribution center.

In the supply chain management context, having the visibility into the specific trade promotion tactics being used, and timeframes of the trade promotion tactics, is a major unlock for the supply chain manager to understand the context around the forecasted increase in demand at a retailer, driven from advertising or pricing action on the shelf. With ability of the disclosed system to link shelf-level retailer demand to the distribution centers using distribution point forecasts, the shelf-level deals will translate to demand at the customer distribution centers. This can then be directly compared to orders that the customer has placed to arrive at the customer DC in question. Further, if there is a discrepancy between the orders placed at the planned demand, the supply chain manager can more effectively communicate with the customer by citing the specific trade promotion tactics being used and reconciling the internal promotion plan with the customer's promotion plan. By embedding the trade promotion aspects in the demand planning view, the disclosed system can maximize the efficiency of the collaborative planning, forecasting, and replenishment workflow. Unlike statistical forecasting tools, which may or may not overlay a high-level sales forecast, detailing the specific promotional tactics being used has not been observed in the operations management context.

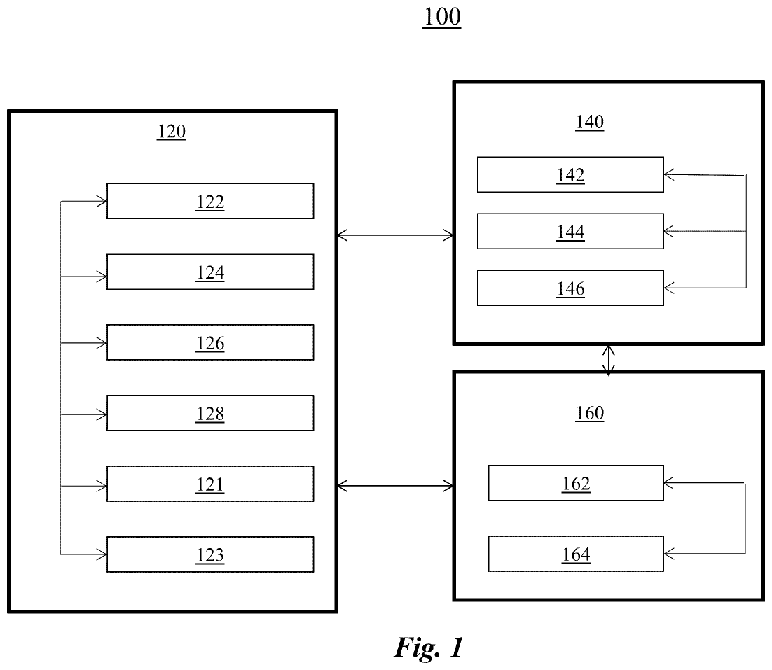

FIG. 1 is a schematic diagram of functions 100 of an organization associated with a CPG brand. To successfully commercialize a CPG brand, various functions in the organization need to plan aspects of their growth to anticipate organizational needs. The exemplary activities of these functions are enumerated below.

For operations department functions 120, the activity can include demand planning 122. Demand planning 122 can include a supply chain management process of forecasting, or predicting, the demand for products. The demand planning 122 can often focuses on product case shipments by customer warehouse.

The activity of operations department functions 120 can include supply planning 124. Supply planning 124 can include the entire planning process which includes distribution, manufacturing, and procurement operations according to demand forecasts.

The activity of operations department functions 120 can include materials resource planning (MRP) 126. MRP 126 can work backward from a production plan for finished goods, which is converted into a list of requirements for the subassemblies, component parts, and raw materials needed to produce the final product within the established schedule.

The activity of operations department functions 120 can include requirements planning 128. Requirements planning 128 can include management of finished goods allocations across a manufacturer's inbound distribution centers to ensure the inventory is in the correct place.

The activity of operations department functions 120 can include sales and operations planning 121. Sales and operations planning 121 can include an integrated business management process through which the executive and/or leadership team continually achieves focus, alignment, and synchronization among all functions of the organization.

The activity of operations department functions 120 can include customer order validation 123. Customer order validation 123 can include the act of comparing orders to the forecast to ensure that customers are not overstocked, throwing off the supply plan and incurring spoilage, or understocked, causing lost sales through voids on shelf.

For sales and marketing department functions 140, the activity can include sales planning 142. Sales planning 142 can include the act of planning a brand's sell through on shelf and the accompanying wholesale gross sales implications.

The activity of sales and marketing department functions 140 can include trade promotion management 144. Trade promotion management 144 can include the management of trade promotion, or marketing spend that occurs between the retailer, distributor, and/or brand. Most trade promotion activities can affect the price of the products on shelf.

The activity of sales and marketing department functions 140 can include revenue growth optimization 146. Revenue growth optimization 146 can include the practice of determining the optimal promotional plan to sell the most product for the lowest cost of sales.

For finance 160, the activity can include financial planning and analysis (FP&A) 162. The FP&A 162 can include the cycle of understanding the year-to-date actual performance with the year-to-go projections. FP&A 162 has substantial implications with cash-flow analysis and profitability projections.

The activity of finance 160 can include trade reconciliation 164. The trade reconciliation 164 can include the practice of validating promotional spend against planned spend and challenging outliers.

### Demand Planning 122 (Shown in FIG. 1)

In various embodiments, the bottom-up methodology can be used in demand planning 122. Stated somewhat differently, emerging brands can employ a bottom-up methodology. The method can build demand from granular assumptions and assign the volume to the correct upstream nodes in the supply chain. Often, this appears in the matter as set forth below. In various embodiments, an upstream (or up stream) node can include any one of the nodes in the supply chain that come before a given location. For example, a production plant can be upstream from the retailer.

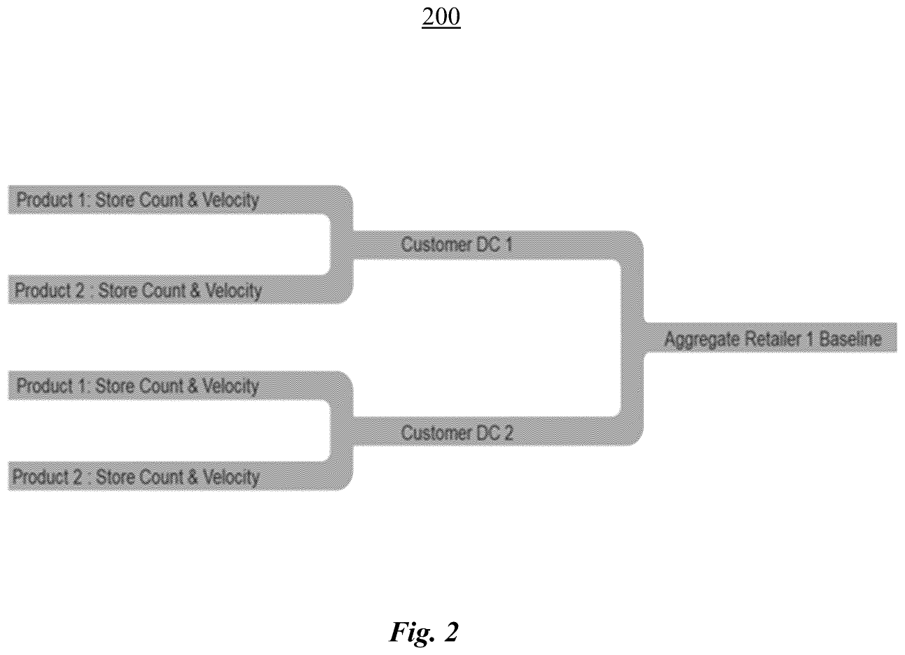

FIG. 2 is a diagram illustrating a method 200 for demand planning 122 (shown in FIG. 1). In FIG. 2, the brand can plan products not only at each retailer, but also through the distribution centers that feed that retailer's stores. In the above, each product and DC combination has an associated store count and velocity, defined as “units per store per week.” The aggregate demand for that retailer encompasses all the baseline, or unpromoted, demand through the customer distribution centers that supply that retailer.

Looking at a top-line volume call, the total demand for a brand's products is the aggregate of all their planned retailers' baseline and promoted volume. The top-line volume call can include total gross sales for a brand. This methodology can be necessary for growing brands due to the fact that their baseline velocities are changing, promotional plans are irregular, and new retailers and opportunities present themselves for which the brand has no prior data with which it can draw conclusions. For example, no statistical model or algorithm can accurately gauge whether the category manager at a major grocery chain will accept the products or not. When that happens, the brand will need to continually monitor and react to changes in the rates of sale vs. looking at a model.

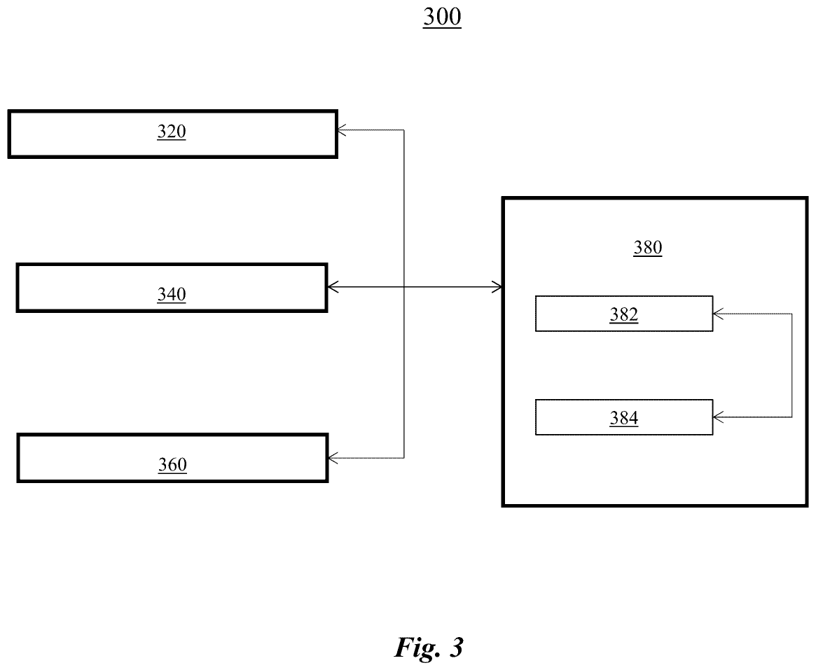

FIG. 3 shows a diagram of entities 300 associated with master data regarding the supply chain and promotional details. The data 300 can be stored in a tab (for example, labeled as “World” tab) in the user interface. The tab can represent a central place for master data within the disclosed system. The central place can represent the “World” in which the organization conducts business. The system can model retailers, products, product groups, distributors, manufacturer DCs, customer DCs, and all other entities that constitute the organization's supply chain and how the products move from the plant that manufactures the products to the retailer store where the products are sold to a consumer. The entities 300 can include retailers 320, products 340, product groups 360 and/or distribution centers (DCs) 380. The retailers 320 can be represented by modeled retail banners from which the plans are constructed. The products 340 can include individual consumer units that are planned. The product groups 360 can include groupings of products that share the same characteristics such as price point, case-pack, and retail manufacturer's suggested retail price (MSRP). The DCs 380 can include manufacturer DCs (or Inbound DCs) 382 and/or customer DCs (or outbound DCs, consignees, ship-to's) 384. The manufacturer DCs 382 can include the distribution centers that are employed by the manufacturer to pick, stage, and ship cases of product to customer DCs. The customer DCs 384 can include the site that the manufacturer ships the product to. In various embodiments, a retail banner can include a named retailer. In one example, “retail banner” and “retailer” can be synonymous, so the retail banner can be a retailer. In another example, a retailer can own one or more retail banners (or divisions or subsidiaries that each can also function as a retailer with a brand).

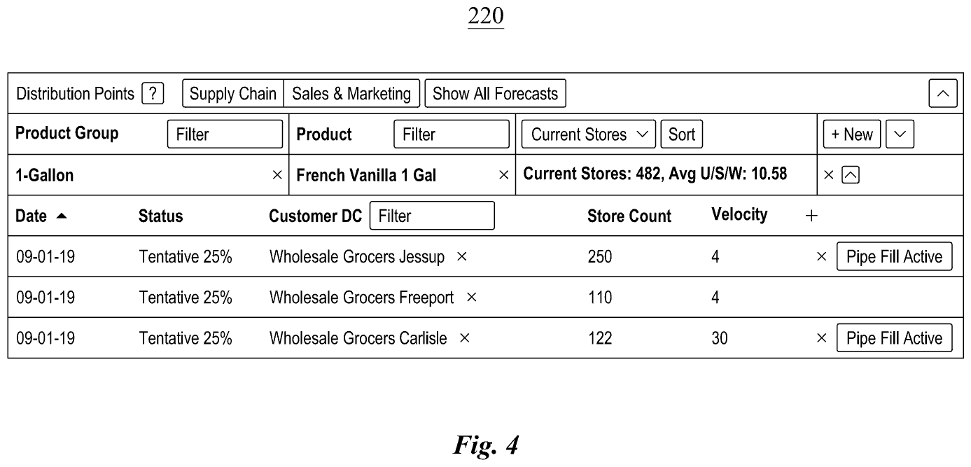

FIG. 4 shows an exemplary distribution point forecast interface 220 used in demand planning. The demand planning 122 (shown in FIG. 1) starts at the retailer level using what are called “distribution point forecasts.” These are database entries in which a product is assigned to a given retailer through a given distribution center. Each of these distribution point forecasts are given an effective date, a customer distribution center, a store count, and a velocity (units per store per week) that becomes the weekly baseline volume forecast for that product through the given distribution center until an overriding distribution point forecast is applied. Each distribution point forecast aggregates to the total demand for the retailers' customer distribution centers. Because customer distribution centers are linked to manufacturer distribution centers in the supply of products, each distribution point forecast can aggregate to the total demand for manufacturer distribution centers (or inbound DCs) as well. In various embodiments, sales planning can include planning the amount to sell through the register (or a till, or a cash register). Demand planning can include planning the amount to sell to the customer (distributor or retailer) and when to sell. Volume planning can include sales planning, demand planning, and/or any other type of planning of quantity for CPG.

Once the baseline forecasts are created from the distribution points, seasonality multipliers are applied by week, by product group. Once this seasonality is applied, the disclosed system calculates the seasonality adjusted baseline forecast.

Promotions that are planned then have an incremental percentage lift to the baseline applied between the start and end dates. For example, a promotion with “50” entered into the lift metric will increase the seasonality adjusted baseline forecast by 50%. This is represented below:

[Seasonality adjusted Baseline]*(1+[promotion lift]/100)=Total Forecasted Units

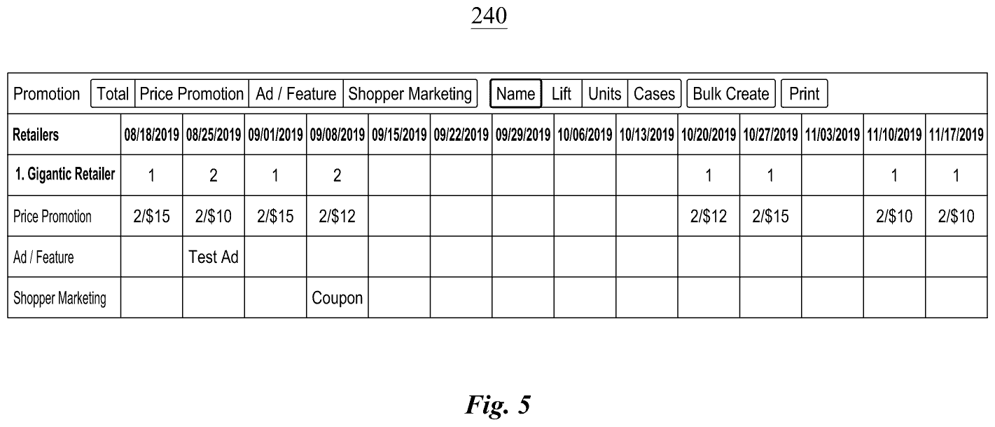

This promotion lift is applied to the forecast going through a particular retailer, filtering down to the projected demand at the supporting distribution centers. FIG. 5 shows an exemplary interface 240 illustrating a promotion calendar at an exemplary retailer. The interface 240 can be a form of a promotion plan as represented in the disclosed method.

Until this point in the process, the demand planning has operated from a consumption basis, considering how consumers will buy the product from the shelves. To achieve an operational demand plan in cases, products belong to one product group, with an associated case factor, representing the number of consumer units in a wholesale case of product. In various embodiments, a case can include a physical case of multiple consumer-bought products. For example, a case of beer (or other items) can be a standard selling unit of a brand. These case factors (customizable by retailer) can convert the unit demand plans into cases:

$$[ Units planned at retailer ] / ( [ Product Gruop Case Configuration ] ) = [ Total Cases Planned at Retailer ]$$

In the equation as set forth above, “units planned at retailer” can include a total number of consumer bought units planned. “Product Group Case Configuration” can include the number of units in each case. In an illustrative example, if a case of cookies contains 12 packs of cookies, a forecast of 144 units scanned through the register can translate into a forecast of 12 cases.

To further transform the consumption plan into the operational demand plan (or delivery forecast in the disclosed method), offsets are input at the customer DC level to move the consumption demand back to when it is anticipated to be delivered into the customer distribution center. The delivery offsets are entered by the user, to model when volume forecasted to be consumed at the retailer store needs to be delivered to the customer distribution center. These are known configurations specific to customer distribution centers based on known lead-times for product to get from customer DCs to the retailer stores. These are modeled at a forecast (an active value at a point in time) so different lead times can be modeled as they change over time. From a user's perspective, volume increases that occur on the retailer's shelf, such as those from pricing actions, must be moved back in time according to the operational lead time it takes the product to get from a customer DC to the retailer that is responsible for the increased demand. This offset allows the creation of the forecast of demand at both the retailer as well as the customer DC that supplies the retailer.

Further, new products on shelf require deliveries that do not mirror consumer behaviors. These “pipe-fills” are required by the retailer to ensure that enough product is available to fill the shelves at launch. In the disclosed method, “pipe-fills” are managed in “pipe-fill configurations” which are applied toward incremental stores planned via distribution point forecasts.

These pipe-fill configurations are applied at the retailer and/or product group level and have three parts: offset weeks, cases per incremental store, and skip weeks. When a pipe-fill configuration is active for incremental stores, the offset weeks denote the number of weeks ahead of the new store launch that the product is required in the customer's distribution center, the cases per incremental store increase the case volume necessary to deliver in that timeframe, and the skip weeks denote the number of weeks that do not have baseline volume in the delivery forecast.

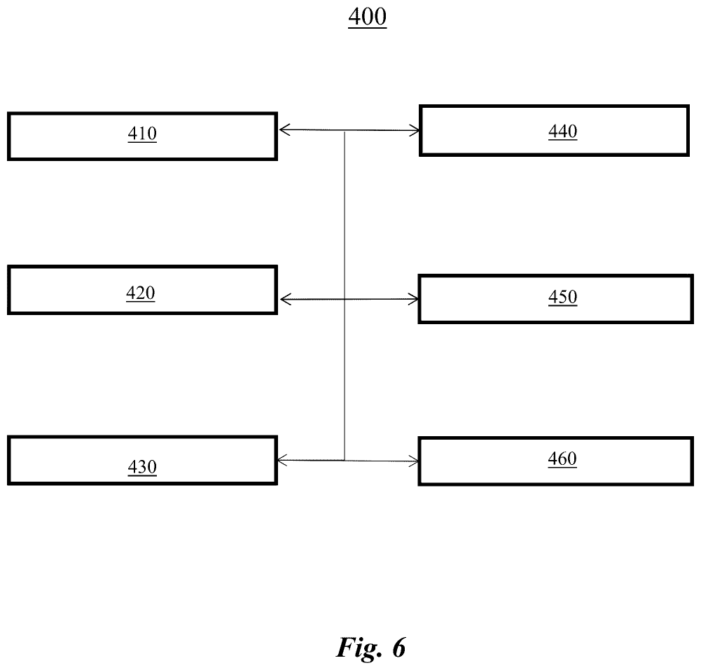

In various embodiments, variance Analysis can be used in demand planning 122 (shown in FIG. 1). FIG. 6 is a schematic diagram of data streams 400 that can be ingested based upon the disclosed method. In various embodiments, the data streams 400 can include six separate data streams to compare the forecast at various levels of the value chain. The data streams 400 are shown as including order shipment data 410, consumption scan data 420, distributor shipments data 430, inbound DC inventory data 440, plant inventory data 450, and/or distributor inventory data 460.

By Integrating data from across the value chain, the user can have myriad data points to not only understand the actual forecast, but the nuances that surround why the forecast behaved like it did.

The forecast can be bottom-up, meaning that the forecast can aggregate and transform from a series of variables that model the reality of the business, and uses real-world data (or actuals) to tune performance of the business. For example, the user can see every variable that constitutes a current demand forecast including, for example, the baseline demand, seasonality modifier, promotion plan, pipe fill and/or skip week adjustments. When the forecast is different from the user's expectation, the user can drill down to what component caused the forecast number to arrive at the final calculation. Additionally, the actuals Data (for example, sales orders, retailer scans, customer DC shipments, inventory positions) are layered on to the forecast where it becomes more apparent where a forecast is different from the actual data coming through.

Demand planners at growing CPG brands are tasked with understanding the forecast variance at multiple levels of the brand's supply chain. If the demand plan did not come to fruition, the user can examine the retailer-level performance. This includes information regarding the average retail price that the product sold for on shelf and the total stores that the product sold in. From here, the user understands whether the forecast variance occurred from incorrect pricing or distribution that was not to expectations. Additionally, because the user can view the case shipments to the customer DCs that supply the retailer, the user can understand if ordering cadence or quantity drove underperformance on shelf.

In some embodiments, the bottom-up method 200 (shown in FIG. 2) for demand planning 122 can be implemented by the following pseudo-code. The method 200 advantageously uses the following data models, and strategically nested loops to calculate forecasted units, for any point in time.

```
Distribution Points: {
  Retailer,
  Customer Distribution Center,
  Product Group,
  Product,
  Forecasts: [
    {
      Date, (active until the next forecast)
      Store Count,
      Velocity,
      Cannibalized,
      Ignore Pipe Fill
    },
    ...additional forecasts
  ]
}
Initialize Forecast Object.
For each week,
  For each Distribution Point for the Selected (Retailers, Customer DCs,
Product Groups, Products)
    For each Distribution Point Forecast
      Get the Forecast that has a date immediately before, or
matching the week.
      Multiply the Active Forecast Store Count by Velocity for
volume.
      Add that baseline velocity to the forecast for subsequent
reference.
For a given week, the distribution point store count is multiplied by the
velocity to give us the baseline volume (units per store per week).
Seasonality Forecasts: {
  Retailer,
  Product Group (collection of products),
  Date,
  Lift
}
For each week,
For each Seasonality Forecast that matches the week and Product Group.
  Multiply seasonality lift by referenced, matching baseline velocity.
  Store that calculation in Forecast Object as ‘adjusted baseline units’
If there is a seasonality forecast, for the retailer and product of a given
distribution point, multiply the lift by the baseline volume, and add it to
the baseline volume to get the adjusted baseline units.
Promotion Forecasts: {
  Retailer,
  Promotion Group (collection of products)
  Start Date,
  End Date,
Lift,
Shipper,
Shipper Quantity
}
If there is an active promotion forecast (the current date is between the
start and end date of the promotion), the multiply the lift by the adjusted
baseline units. This is your promotion units.
If the promotion has a Shipper, then apply the underlying product volume
in each shipper to the forecast.
Shippers: {
  Products: [
    Product,
    Number of Units
  ]
}
```

For each Product, the Number of Units is multiplied by the Quantity on the Promotion, and that is your shipper volume.

The forecasted units calculation is different if it is the Consumption Forecast, or Delivery Forecast.

For the Delivery Forecast, volume is moved backward in time by the number of “Delivery Offset Weeks” for the Customer Distribution Center, for each Distribution Point in the forecast. Additionally, Pipe Fill and Skip Week volume adjustments are made.

The Pipe Fill volume is a quantity of user-defined cases per store times the number of new stores during a distribution increase that is placed in the “Pipe Fill Date”. Then, the number of Skip weeks have the increased in baseline volume decremented from the following number of Skip weeks. This accounts for the fact that the volume in this distribution increase has been addressed by the pipe fill volume. These pipe fill configurations are made by Product Group, for each Retailer.

### Trade Promotional Management 144 (Shown in FIG. 1)

By integrating the supply chain mapping components of the disclosed method with the trade promotion management 144, the disclosed method can serve as a fully integrated solution. The operations teams can access the information they need, always aligned with the latest information from the sales department.

The disclosed system can include a trade promotion management module (not shown). In various embodiments, the trade promotion management module can be configured for fully developing the function of sales planning 142 (shown in FIG. 1). In various embodiments, the sales planning 142 can encompass both the gross sales created by the demand planning 122 (shown in FIG. 1) and the cost of creating the gross sales. The cost of creating the gross sales can be at least partially managed by the trade promotion management 144. Like the demand planning 122, sales planning 142 can start at the retailer level using the “distribution point forecasts.” These are database entries in which a product can be assigned to a given retailer through a given distribution center. Each of these distribution points generates a volume call for the retailer they are assigned to. From here, this volume is cross referenced with the product group configurations.

In various embodiments, the trade promotion management module can be configured for implementing promotion planning, such that the brand can both hit the gross-sales numbers while simultaneously monitoring the trade spend.

Workflows in the promotion plan promote accountability and safeguards against errant brokers or sales managers adding unprofitable or unfunded promotions into the plan. With the disclosed method, brands can assign approval permissions to those who can approve or deny trade promotion plans. Additionally and/or alternatively, to support having third parties and other members of the broader sales team contribute to maintaining the promotion plan, the disclosed method can offer permissions in which non-approvers can propose changes to the promotion plan, or they can propose to change the time-window of an approved promotion without the approval step. In various embodiments, the users who are non-approvers would require approval if such users are to expand the scope, or other selected aspects, of the promotion. Trade managers can then review the implications of a proposed promotion before accepting or rejecting the promotion program.

Permissions exist in the disclosed system which can determine how a user is able to manage promotions within the app. One of the permission sets allows the user to make changes to a promotion, but those changes are “pending” until they are approved by a user with the ‘promotion approve’ permission. The “pending” promotion will show up in the calendar as pending, but if there is a previously confirmed version of the promotion in the system, that version will continue to impact the downstream demand and trade metrics until the promotion is approved. The promotion reviewer will see the proposed promotion change in the “promotion review” interface, as well as what impacts on demand and trade metrics accepting the promotion would have. Based on this information and insight, the promotion reviewer can make the informed decision.

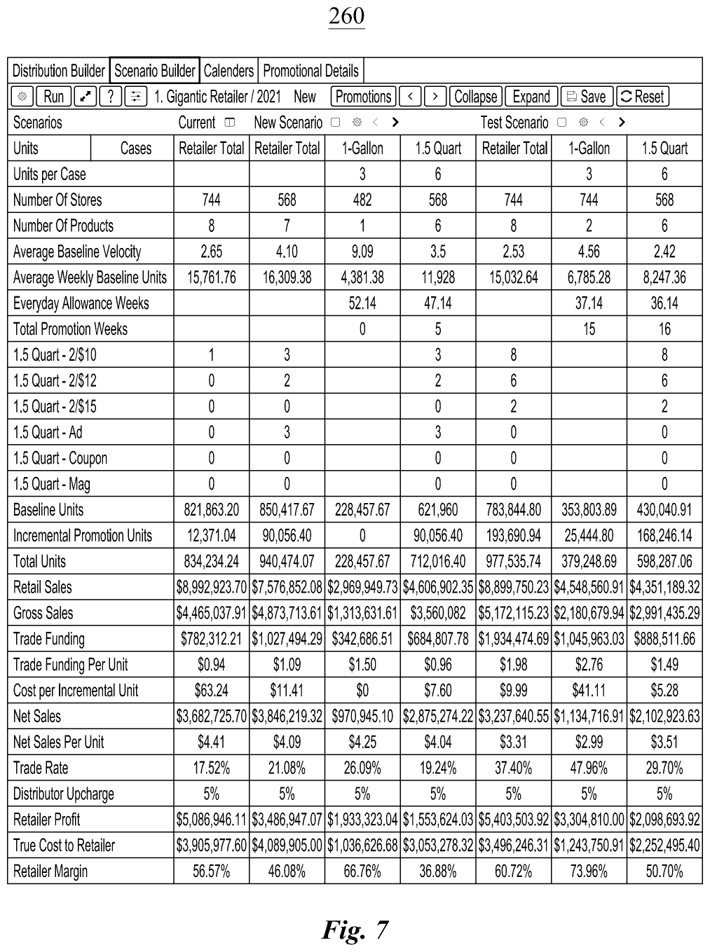

In various embodiments, the trade promotion management module can be configured for implementing promotion scenario planning. The first step in developing a promotional calendar is to build scenarios that may be acceptable for the retailer's category manager. In the disclosed method, promotion scenarios can leverage the current baseline variables as the starting point for the scenario. The user can input the number of weeks of each promotion type. The user can view comprehensive results from each promotional scenario and its impact on a full year. FIG. 7 shows an exemplary interface 260 illustrating an exemplary scenario planner.

The disclosed system is configured to include a scenario planner (or scenario builder) that starts with the bottom-up baseline forecast for the selected retailer in question. From there, the user can view the current metrics for the full year (or previous or current years) at the retailer and at each component product group level. The disclosed system can make new assumptions with these scenarios, such as changes in baseline velocities and every day low price configurations. Next, the user is able to view the current promotion templates that are available for that retailer, and see what metric impact would occur from having promotions running for different number of weeks. Additionally, the user can view those promotion templates and edit them directly in this scenario planning interface, which gives the user all the contextual information needed to plan current and future year promotion plans, and change promotion templates as needed for ideal deal scenarios. Finally, when a user has a scenario they have vetted and approved and want to add into the business plan, they can actualize this scenario in this interface and “calendarize” the promotion by breaking the ‘weeks running’ into a series of start and end dates used to create planned promotions.

In addition to the planner, the disclosed system has several algorithms that enable creation of optimized promotion scenarios. This starts with the optimization targets and constraints needed from the business (For example, optimizing for gross sales, which ensures a minimum retailer margin and maximum trade rate are met). Then the system uses 2 algorithms to arrive at the optimized scenario.
1. Sample Search: the system starts with several combinations of promotion frequencies spread across the spectrum of all possible frequency combinations. From each combination, the system then uses a modified gradient descent approach to move from each of those frequency combinations in a direction that increases the optimized value while maintaining the constraints.
2. Brute Force: the system works through every possible combination of promotion frequencies and check the outputs against our output constraints.

The system runs both optimizations concurrently upon user request, and return the most optimal scenario for the constraints. It will either run until the true optimal is found, but can be time-scoped by the user to return a near-optimal scenario in a determined amount of time.

In various embodiments, the trade promotion management module can be configured for implementing post promotional analysis. Brands need analytical horsepower to understand which promotion types are profitable or drive compelling sales stores with retailer category managers. The practice of understanding promotional performance can be called “post promotional analysis.” This can be done in a few ways. First, the team can leverage syndicated scan consumption data overlaid against the forecast. The system can provide a simple analysis of the actual promotion lift from the data that is fed. The user can decide whether the promotion lift can be updated in the greater context of how the product performed.

The recommendations engine of the system uses worker servers to run these promotion lift recommendations on user request, as well as on a daily cadence every evening. This ensures that the user is kept apprised of the latest data in the system and what recommended changes are proposed to keep the promotion lifts as accurate as possible. In practice, the algorithm is such that:
1. Filter promotion forecasts with at least 1 day in recommendation time frame
2. Calculate daily retailer product metrics
3. Calculate and proportionally allocate scan units to the daily, retailer, product level.
4. For each promotion, calculate the actual units during the promotion time frame divided by the baseline units in that same time frame to determine the actual promotion lift.
5. That new lift and current lift are captured along with the forecast metrics (units, gross sales, net sales, trade rate) from the proposed change to the promotion lift.

In various embodiments, the trade promotion management module can be configured for implementing promotion approval workflows. To ensure that the promotional planner is controlled and managed by those who control the trade spend budget, the system can provide a number of permission tiers to grant users differing levels of autonomy in managing the trade plan.

In various embodiments, the system can implement approval permission. Users with this permission can plan promotions and approve proposed promotions.

In various embodiments, the system can implement permission of proposing. Users can propose promotions into the plan, teeing up before and after metrics to the trade managers.

In various embodiments, the system can implement promotion window change permission. Users can update the window that the promotion is planned to run, without increasing or decreasing the total length of the promotion.

### Customer Order Validation 123 (Shown in FIG. 1)

Through the Distribution Center forecast developed at each retailer, the disclosed method aggregates the total retailer demand through a given warehouse. Since orders in the retail supply chain are placed to arrive at a distribution center, the brand can compare the orders that are placed to the warehouse's forecast, to understand the forecasted stock position of the customer's warehouse at a given day. In accordance with various embodiments disclosed above, the system can use the distribution points and calculated proportionality to aggregate and/or disaggregate data to forecasts at different scopes.

The disclosed system can include an order validation module (not shown).

A major issue that brands face is customer warehouses running out of stock to service demand. Conversely, customer warehouses could order significantly more than planned, created supply chain, cash flow, and unanticipated trade spend issues. The order validation module can provide a customer “days-on-hand” prediction tool leveraging actuals as well as forecasted store shipments.

“Days-on-hand” can include a measure of how many days a customer's inventory will last after accounting for product spoilage and demand fluctuations. The algorithm can loop through each day to generate a starting and ending inventory for each day. From there, the order validation module can calculate the days-on-hand based on when the starting inventory is predicted to be less than a day's worth of demand. Ending inventory can be calculated as following:

$$[ Starting inventory ] - [ Daily Demand ] - [ Shrink Risk ] + [ order ] = [ Ending Inventory ]$$

In the equation as set forth above, starting inventory can include inventory that exists at the beginning of a given day. Daily demand can include total cases projected to be sold through that distribution center in a given day. The daily demand can deplete the starting inventory. Shrink risk can include algorithmically-calculated spoilage in the customer DC 384 (shown in FIG. 3) based on inventory not able to fulfill retailer requirements with regard to shelf life. The shrink risk can deplete the starting inventory. Order can include inbound order(s) that are delivering to the customer DC 384 from the brand. The order can increase the inventory level. Ending inventory can include the balance of inventory at the end of the given day.

According to the disclosed method, lot codes are assumed on a “worst case scenario” basis in which orders coming in have the “minimum guaranteed days of shelf life” and must ship out before a “minimum days to ship to stores” variable on the customer warehouse.

Date Handling and aggregations can be based upon the following frequencies and ranges, including daily, weekly, monthly, yearly, and/or quarterly, and retailer, customer DC, manufacturer DC, product and/or product group.

Actual Starting Inventory data can be overlaid against the projected starting inventory, effectively resetting the model. This would include actual case quantities at a given point in time (effective date) and their associated expiration dates that will inform the modeled spoilage (shrink) risk.

### Advantages Over the Prior Solutions

Unlike other solutions, which focus on either the demand planning domain or the trade planning domain, the disclosed method offers an integrated solution whose algorithms can ensure the necessary data transformations are made to allow all departments to leverage the data to inform their specific use-cases.

The unique bottom-up architecture of the disclosed system, in which customer DCs are tied to the retailers who receive product from them and the customer DCs are similarly tied to manufacturer DCs, allows the sales team to plan sales, trade spend, and retailer margin at the retailer-level, while operations can receive case-level forecasts throughout the value chain. This integrated approach aligns the needs across the entire brand's departments to a single system, resulting in a holistically better forecast.

Additionally, the distributed backend architecture of the disclosed system allows for near-infinite scalability without degradation of service, unlike locally-based spreadsheet systems that rely on local system resources. The system employs an internally designed architecture called “monolithic microservices”. This constitutes a number of technical design decisions and implementations which enable our scalability both at the application program (or app) level and the individual organization level.
1. Every server in our infrastructure has the full application deployed to it. We then only call part of the application on a respective server based on the needs of the app or the organization. This allows us to scale and utilize the disclosed method on multiple servers in a distributed manner. For example, if we find that our authentication service is becoming a bottleneck, we can create another server configured to implement the method, and use that server to handle all the authentication calls. But because each server has a fully deployed version of the application, we eliminate the data duplication and transmission issues that arise in a traditional microservices model.
2. There are two types of Servers we use: A web Server and a worker Server. The web Server handles our synchronous work (where a user makes a request and expects a response in a reasonably short amount of time). The HTTP request will remain open, waiting for a response on the browser from the Web server. This is used for all requests where the user expects to wait for a response in their browser, like updating a retailer or creating a product. A worker server handles our asynchronous work. That is where the HTTP request from the browser will send and receive a response quickly letting them know their request was added to the job queue. The worker server will process the jobs from the queue in a FIFO (first in first out) model and use Websockets to send progress messages to the user as well as a completion or failure message depending on if the work was successful. Upon receiving those messages, the browser will fetch and render data from the completed work to display in the browser app.
3. We have a “Primary” database and multiple “Storage” databases. The Primary database holds the organization and user information for all of the system. For each organization, we store the Storage Database, the Web Server, and the Worker Server the organization will use. We can have multiple organizations using the same database, Web Server, and Worker Server, or a single organization having a dedicated, single-tenancy instance of each. In the former example, we can utilize our resources effectively by having small and “like” organizations share database and compute resources and move to increase those server capabilities or move organizations to dedicated servers as the performance metrics dictate. In the latter example, we can provision dedicated servers to an organization, and vertically scale those servers as necessary based on the client organization's needs.
4. These operations to right-size server and compute resources based on the organization and app performance needs, and made simple through an Admin App. This application has administrative functions such as exporting and importing organization data to new databases, assessing the performance of, and performing automated tasks such as regular organization level data backups.
5. Part of the value of the system is the timeliness and availability of the latest forecasts. These forecasts can take minutes or longer to calculate depending on the size of the organization and the desired forecast parameters. As a result, we utilize caching of forecasts using .csv files and Amazon Web Services (AWS) Elasticache (available at Amazon Web Services located in Seattle, Washington, U.S.A.). This gives us an elastic (scale on demand) file system we access through our Web Servers and Worker servers. The caching process works through the following process:
   A. When the user requests a forecast, the web server will first check if a cache file already exists for the requested forecast. If it does, it will stream the CSV file into memory, and return that forecast object to the requesting client.
   B. If the forecast cache does not exist, the web server sends the necessary information to the worker server, which will construct the forecast at the next available opportunity, store it as a CSV file, then send a Websocket message to the client telling it that the requested forecast is ready to be retrieved. Upon receiving that message, it will repeat the process from bullet ‘a’ and this time the forecast will exist and be ready to be pulled into the client.
   C. As any number of specific forecasts can be requested, these cached forecasts have a maximum “time of live” of 1 day. The system, however, employs “presets” which are saved forecast configurations that the user can request. These forecasts live in the cache indefinitely and are updated whenever source data changes.
   D. When source data changes for a “preset” forecast, a new smaller forecast is constructed for the full time frame of the preset forecast and for the specific entities (retailers, products, or the like) that are affected by the data changed. That new forecast is merged with the current cached forecast so the cached forecast is always kept up to date with the latest data.
      Additional and/or Alternative Features of the Disclosed Method and System

The disclosed platform can include a logic-intensive system that has a significant number of elements and methods that, if taken individually as well as combined, are unique features working together to create a novel whole. The following will explore selected specific elements.

Method 1 includes bottom-up sales planning and supply chain mapping architecture. Method 1 can include the business logic involved in mapping a supply chain over time by product and/or product group. For example, the logic can be based upon a flow of following: Retailer Sales Volume->Aggregate Outbound DC Stock Requirement->Aggregate Inbound DC stock requirement. The system models all aspects of the business and world data (or data relating to the organization and products it produces as well as the world in which it conducts business) on a forecast. That means a data configuration is active on a specific date and remains active until a configuration exists with a future date, or that configuration remains active into the future indefinitely. For example, the system models the case count and case count of a collection of products for a given retailer on a forecast.

```
<Product Group>: [
  { <Date 1>, <Case Count>, <Case Cost> },
  { <Date 2>, <Case Count>, <Case Cost> }
]
```

When constructing a forecast, create an intermediary forecast <Retailer/Product/Week> and build out the active values for each forecast point (specific Retailer/Product/Week within the intermediary forecast)

{<Retailer_Product Group_Week Date>: {caseCount, caseCost}}

This forecast is keyed (or identified) by a combined string of the retailer, product group, and week date. That enables a constant lookup time when referencing a forecast point value to apply to a base forecast, intermediary forecast, or domain forecast. From a business perspective, this allows modeling changing business requirements over time while maintaining a memory and time efficient process for forecasting.

The bottom up forecast that begins with a distribution point (a number of product units sold from a number of retailer stores per week, sourced from a specific customer distribution center). The customer distribution center receives product from a manufacturer distribution center, and therefore the forecast can be aggregated to the manufacturer distribution center level. These ‘receive from’ configurations at the customer distribution center dictate which manufacturer distribution center it receives product from, and is structured in the same way as the retailer product group configuration example above. Exemplary customer distribution center ‘receive from’ configuration can be the following.

```
<Product Group 1>: [
  { <Date 1>, <Manufacturer Distribution Center 1> },
  { <Date 2>, <Manufacturer Distribution Center 2> }
]
<All other Product Groups>: [
{ <Date 1>, <Manufacturer Distribution Center 1> },
]
```

This models that the Customer distribution center receives products from Product Group 1 from Manufacturer Distribution Center 1 from <Date 1> until the week before <Date 2>. From <Date 2> on, the Customer Distribution Center receives products from Product Group 1 from Manufacturer Distribution Center 2 into the future. All other products not in Product Group 1 receive product from manufacturer distribution center 1 from <Date 1> into the future. This gets constructed into an intermediary forecast in the shape of:

{ <Customer Distribution Center_Product_Week Date>: { Manufacturer
Distribution Center } }

The configuration above can be mapped to a base forecast, intermediary forecast, or domain forecast. This is how the system dynamically connects the Customer Distribution Center to the Manufacturer Distribution Center over time, as supply requirements change for the different products at different points in time.

Method 2 includes promotional planning volume disbursement. Method 2 can include the business logic involved in mapping promotional plan impacts upstream in a supply chain over time by product and/or product group. Method 2 can include retailer promotional plans that lift the aggregated baseline forecasts for the retailers through the customer warehouses that supply the volume. This logic can be amended to be a forecast by product group.

Promotions are planned at the retailer(s), distributor(s), or customer distribution center(s), promotion group level. A promotion Group is a collection of products that are promoted together. As a result, a promotion can be distilled to volume and cost attributes applied at the retailer and/or Product level. The system is then able to apply promotions to the distribution point level (Retailer, customer DC, and/or product).

In practice, the system has a base forecast at the Retailer/Customer DC/Product/Day level, and for each promotion, the system applies the volume based on the time frame of the promotion and the proportion of customer distribution centers shipping product to the retailer(s) that the promotion is for:

```
function applyPromotionVolume({
  baseForecast,
  customerDCProportionMap,
  dayNumberMap,
  numberDayMap,
  dayToWeekMap,
  promotionForecasts
}) {
  for (const entityId in promotionForecasts) {
    const promotionForecast = promotionForecasts[entityId]
    const {
      retailerEntityId,
      products,
      startDate,
      endDate,
      lift,
      pricePoint,
      type,
      costStructure,
      percentOfForecast,
    } = promotionForecast
    const liftDecimal = convertPercentToDecimal(lift)
    const retailerEID = shortID(retailerEntityId)
    for (const productEntityId of products) {
      const productEID = shortID(productEntityId)
      // For each day in in promotion time frame
      let currentDate = startDate
      while (currentDate <= endDate) {
        const activeWeek = dayToWeekMap[currentDate]
        const proportionKey = ‘${retailerEID}_${productEID}_${active Week}‘
        if (customerDCProportionMap[proportionKey]) {
          for (const customerDCEID in customerDCProportionMap[proportionKey]) {
            const key = ‘${retailerEID}_${customerDCEID}_${productEID}_${currentDate}‘
            if (baseForecast[key]) {
              const forecastPoint = baseForecast[key].consumption
              const { baselineUnits, seasonalityUnits, promotionPricePoint } = forecastPoint
              // Take the lowest active promotion price point
              if (type === ′PRICE′ && pricePoint !== null) {
                forecastPoint.activePromotionPricePoints.push({
                  entityId,
                  pricePoint,
                })
              }
              // Capture Promotion Lift
              forecastPoint.promotionLift = lift
              // Caclulate Daily Promotion Units
              const dailyPromotionUnits = (baselineUnits + seasonalityUnits) * liftDecimal
              forecastPoint.promotionUnits += dailyPromotionUnits
            }
          }
        }
        currentDate = numberDayMap[dayNumberMap[currentDate] + 1]
      }
    }
  }
}
```

Method 3 includes order management logic and approach. Method 3 can include the business logic involved in determining the stock position, in cases and in “days on hand” of a customer's warehouse. Additionally and/or alternatively, method 3 can include layer in auto-calculation logic to optimize sales orders. The customer DC days-on-hand calculations can incorporate: the current inventory level of the customer DC; the projected demand derived from calculations based upon the disclosed method; the projected product spoilage of the customer DC based on supply chain shelf-life guarantees; the new orders delivering to the customer's warehouse; the calculated days-on-hand by algorithmically going through each day's demand; and/or the ending inventory in a given period.

The system maintains a mapping from Dates to Numbers, and Numbers to Dates. That way, the system can make arithmetic calculations for dates (moving day by day, week by week) efficiently and quickly. This was a critical step for traversing the forecast quickly, compared to native date arithmetic.

The below function takes an intermediate forecast (customerDCProductForecast), calculated from an underlying base forecast (Customer DC/Retailer/Product/Day) metrics. After applying Customer DC Inventory positions and Sales Orders, the system can go through each day in the forecast and determine the days on hand from that point in time. This is achieved through iterating through the forecast and deducting shrink and demand from each following day until there is no longer inventory available from the point in time the days on hand calculation began.

```
function calculateCustomerDCDaysOnHand({
  selectedCustomerDCs,
  selectedProducts,
  forecastDateMap,
  dayNumberMap,
  numberDayMap,
  customerDCProductForecast,
}) {
  for (const customerDC of selectedCustomerDCs) {
    for (const product of selectedProducts) {
      for (const date in forecastDateMap) {
        const key = ‘${customerDC.EID}_${product.EID}_${date}‘
        const forecastPoint = customerDCProductForecast[key]
        if (!forecastPoint) {
          continue
        }
        let daysOnHand = 0
        let currentInventory = forecastPoint.startingInventory || 0
        let currentDate = date
        while (currentInventory > 0 && forecastDateMap[currentDate]) {
          const nextForecastKey = ‘${customerDC.EID}_${product.EID}_${currentDate}‘
          const nextForecastPoint = customerDCProductForecast[nextForecastKey]
          if (nextForecastPoint) {
            currentInventory −= nextForecastPoint.demand
            currentInventory −= nextForecastPoint.shrink
          }
          if (currentInventory > 0) {
            daysOnHand += 1
          }
          currentDate = numberDayMap[dayNumberMap[currentDate] + 1]
        }
        forecastPoint.daysOnHand = daysOnHand
      }
    }
  }
}
```

Method 4 includes supply planning logic and approach. Method 4 can include a feature set that allows the forecast to be transformed into a stock requirement forecast such that the team can plan inventory production and allocation. The supply planning module can be composed of two main interfaces, network rollup interface and network breakout interface. The network rollup interface can include a primary interface to view the aggregate inventory and demand signal over time for the creation of purchase and/or production orders. The network breakout interface can include a primary interface to allocate inventory and build truckloads from that allocation.

The network breakout forecast is a transformation of the delivery forecast based on the supply planning variables at the Customer Distribution Center, Manufacturer Distribution Center, Plant, and Product level.

The following function calculates the Plant Inventory Forecast from the intermediate forecast (plantProductForecast) which is an aggregation of the base forecast. Within this functionality, the system maintains an inventory position map, which tracks which inventory positions exist at the plant from explicit inventory records to purchase orders which have new product produced at the plant.

```
function calculatePlantInventoryForecast({
  selectedPlants,
  selectedProducts,
  forecastDateMap,
  dayNumberMap,
  numberDayMap,
  plantProductForecast,
  plantInventoryMap,
}) {
  for (const plant of selectedPlants) {
    for (const product of selectedProducts) {
      for (const date in forecastDateMap) {
        const key = ‘${plant.EID}_${product.EID}_${date}‘
        const forecastPoint = plantProductForecast[key]
        const previousDay = numberDayMap[dayNumberMap[date] − 1]
        const previousKey =‘${plant.EID}_${product.EID}_${previousDay}‘
        const previousForecastPoint = plantProductForecast[previousKey]
        if (forecastPoint && previousForecastPoint) {
          const previousEndingInventory = previousForecastPoint.endingInventory
          let startingInventory = 0
          let replacedStartingInventory
          if (forecastPoint.recordStartingInventory !== undefined) {
            startingInventory = forecastPoint.recordStartingInventory
            replacedStartingInventory = replacedStartingInventory
          } else {
            startingInventory = previousEndingInventory
          }
          forecastPoint.startingInventory = startingInventory
          forecastPoint.replacedStartingInventory = replacedStartingInventory
          const inventoryStatusKey = ‘${plant.EID}_${product.EID}‘
          const shrinkCases = calculateShrinkCases({
            date,
            key: inventory StatusKey,
            inventoryMap: plantInventoryMap
          })
          forecastPoint.shrink = shrinkCases
          let endingInventory = (
            startingInventory
            − forecastPoint.deployment
            − shrinkCases
            + forecastPoint.production
          )
          if (endingInventory < 0) {
            endingInventory = 0
          }
          forecastPoint.endingInventory = endingInventory
        }
      }
    }
  }
}
```

Method 5 includes snapshot history reporting resolution logic. Method 5 can include the tracking and reporting of changes made in the disclosed system over time with their effects on a defined timeframe.

All changes in the disclosed system or method can be tracked so the system can resolve the state of the forecast from any time. The system can include a download feature to make the reporting easier to parse offline.

In the storage database for an organization, every version of an entity (such as a Retailer, Promotion, Product) is stored whenever a change is made. That way, the system can use the Entity ID (unique identifier for a given entity) and the timestamp (unix timestamp, number of seconds that have elapsed since 00:00:00 UTC on 1 Jan. 1970) to determine which version of an entity is active an any point in time. To resolve the history of an entity and the forecast changes, the system follows the following steps:
1. Organize all entity versions by the retailer they affect, in chronological order by the following exemplary pseudo-code.

```
{ <Retailer Entity Id>: { <Timestamp>: { ..data at that point in time } } }
< retailer version> {
  notes,
  productGroupConfigurations,
  edlpForecasts,
  ssaUnpromotedPercentForecasts,
  ssaPromotedPercentForecasts,
  distributionPoints,
  promotionForecasts
}
```

2. For the first version, calculate the business metrics at that point in time.
3. For each chronological version, calculate the new business metrics, and calculate the difference between old and new and previous metrics and store that value.
4. The system does this calculation for all versions within the “Change Time Frame” and calculate the metrics for the extent defined by the “Affected Time Frame”
5. The result shows a description of each change in the system, and how that change affects the aggregate system metrics.

Method 6 includes comprehensive value chain data integration. Method 6 can include integration of data points throughout the value chain that can inform. In various embodiments, such an integration can inform the user of where in the supply chain the variance is observed. By integrating data from shipments, to Customer DC shipments, to scan data, the user can understand where a variance is first observed. The system can uniquely integrate the following demand and inventory signals.

The system can integrate case orders. The case orders can include order data from customers for delivery into customer DCs.

The system can integrate consumer scan data. The consumer scan data can include Consumer purchase data through the register.

The system can integrate customer DC Shipments data. The customer DC shipments data can include distributor and other customer warehouses shipment data to retail stores.

The system can integrate plant finished goods inventory. The plant finished goods inventory can include produced lot-coded inventory sitting at the production facility.

The system can integrate inbound DC inventory. The inbound DC inventory can include saleable product at a brand's warehouse.

The system can integrate customer DC inventory. The customer DC inventory can include inventory of products sitting at the customer's distribution center.

The system can integrate raw materials inventory. In various embodiments, raw materials can include component parts that make up a finished and/or “saleable” product. Exemplary raw materials can include packaging and ingredients. Some brands can require monitoring of the raw materials inventory.

The system uses “forecast chains” to match data at different granularity of entities to the base forecast, or an intermediary forecast. For example, Retailer Scan data is integrated, which models the number of Product units purchased from a number of Retailer stores for a given week. Additionally, Sales Order data which models the number of Product cases delivered to a Customer Distribution Center is also integrated. The system then uses the distribution points to tie these different data models together, by calculating for each Retailer the proportion of volume received from each Customer Distribution Center, and the proportion of Retailers shipped to by each Customer Distribution Center.

An example of this integration is our Forecast Refinement algorithm, which provides a data visualization and interaction interface to view the combined effects of this data and the ability to make forecast changes based on actual data. Similar to the manner of constructing a Domain Forecast from a Base and/or Intermediate Forecasts as described in Method 1 above, baseline, scan, and order volume can be all processed together.

Method 7 includes multi-level bill of material creation. Method 7 can include an assignment of ingredients and quantities that are built at both the unit level and the case level. These bills of material are composed of a quantity of raw materials in a unit of measure that is contingent on the raw materials master unit of measure (UoM).

The system models unit and case bill of materials at the product level, which allows raw material forecasts to be created from any transformed/aggregated forecast that includes a product dimension. The system can then look up the bill of materials for any product at a given point in time. This enables the flexibility to model how bill of materials and pricing terms can change over time.

```
const activeMaterial = getActiveForecast({
  sortedForecasts: sortAscending(
    productBOMMap[productEntityId][key],
    ‘date’
  ),
  date,
  default Value: null
})
```

Pricing can be input at the raw material level as a vendor configuration. These vendor configurations allow the user to define the price per master UoM at different incoterms. The user then selects the planned incoterm when assigning the raw material to the product to source in the price per product dependent on the quantity of the raw material assigned.

Method 8 includes multi-tiered trade spend actualization and forecasting. Method 8 can include the algorithm to resolve trade spend forecasts by parsing actuals at different levels of abstraction. For example, in a first step, if there is an actual cost assigned to a promotion, the system can use that actual cost. If there is no actual cost assigned to a promotion, the system can go to a second step.

If the promotion is “open”, it will only use scan data for determining the actual cost of the promotion. If the promotion is “closed”, it will use the “actual cost” modeled on the promotion, or it will aggregate all deductions tied to the promotion. The resolution is as follows:

```
let actualCost = 0
if (promotionForecast.actualCost !== null) {
  actualCost = promotionForecast.actualCost
} else if (promotionForecast.deductedCost !== null) {
  actualCost = promotionForecast.deductedCost
}
```

In the second step, if scan data exists for each product and/or retailer combination in question, the system can use the scan data as a calculation basis for the forecasted trade spend. If scan data does not exist for each product and/or retailer combination in question, the system can go to step three.

In the third step, the system can use the forecasted cases as a calculation basis for the forecasted trade spend.

In some embodiments, case shipments data can be added to the algorithm persistently throughout the time by the user to actualize gross sales and off-invoice (OI) discount period spend. In various embodiments, the off-invoice discount can include a discount that the brand implements directly on the invoice that the brand sends.

Method 9 includes trade promotion scenario optimization using brute-force algorithm. Method 9 can include an algorithm that optimizes a brand's promotional schedule to maximize gross sales at the lowest cost to the brand. This algorithm takes trade rate and retailer margin constraints to deliver an optimized frequency of weeks for each promotional type.

Details on the Sample Search and Brute Forecast algorithms used in concert to arrive at optimized trade scenarios is set forth above in the section of trade promotional management 144.

Method 10 includes transformation of consumption-based forecasts into a stock requirement forecast. Method 10 can include supply chain behavior variables that translate consumption demand from the store shelves to demand of product from the shipping dock at the brand's inbound logistics provider's warehouse.

At customer DC Level, the variables can include order lead time. Within the order lead time, the forecast should use the actual orders.

At customer DC Level, the variables can include shipping lead time. The shipping lead time can include how long the product takes to be transported.

At customer DC Level, the variables can include delivery day of the week. The delivery day of the week can include when does this product often deliver in the week.

At customer DC Level, the variables can include delivery frequency. The delivery frequency can include how many weeks are between deliveries.

At manufacturer DC level, the variables can include minimum days of shelf life required to ship a product. The minimum days of shelf life required to ship a product can include the required days of shelf life needed to ship the product to customers.

At manufacturer DC level, the variables can include lead time to pick and stage product. The lead time to pick and stage product can include how long it takes for the warehouse to receive, pick, and stage product for shipment.

The above variables can come together to create a stock requirement plan from the delivery forecast. The code to build this is below:

Each of the Customer DC Forecasts follow the same data model, where values are modeled for all products by default or can be set for a particular product group, and are active from the forecast date forever into the future, or until the next forecast date.

```
Order Lead Time Forecasts: {
            <Product Group Entity Id or ‘All Product Groups&rsquo>: [
                <week it's active>: <active value>
            ]
            }
Shipping Lead Time,
Delivery Frequency Forecast,
Delivery Date Forecasts
Stock Requirement Calculation from an aggregated intermediary forecast
function calculateStockRequirementDateMap({
  numberDayMap,
  dayNumberMap,
  deliveryFrequency WeeksMap,
  customerDCProductForecastMap
}) {
  const stockRequirementDateMap = { }
  // Calculate Stock Requirement Dates from Frequency & Day
  for (const cdcProductKey in deliveryFrequencyWeeksMap) {
    stockRequirementDateMap[cdcProductKey] = [ ]
    const sortedFrequencyWeeks = sortAscending(
      Object.keys(deliveryFrequencyWeeksMap[cdcProductKey])
    )
    for (const date of sortedFrequencyWeeks) {
      const { days } = deliveryFrequencyWeeksMap[cdcProductKey][date]
      const forecastKey = ‘${cdcProductKey}_${date}‘
      if (customerDCProductForecastMap[forecastKey]) {
        const {
          deliveryDayOfWeek,
          shippingLeadTimeDays,
          mdcStockAvailabilityLeadTimeDays
        } = customerDCProductForecastMap[forecastKey]
        // Stock is required with shipping lead time and stock availability
        // constraints at the supply MDC taken into account
        const deliveryDateNumber = dayNumberMap[date] + deliveryDayOfWeek
        const adjustedDateNumber = deliveryDateNumber − (
          shippingLeadTimeDays + mdcStockAvailabilityLeadTimeDays
        )
        const adjustedDate = numberDayMap[adjustedDateNumber]
        stockRequirementDateMap[cdcProductKey].push({
          date: adjustedDate,
          days
        })
      }
    }
  }
  return stockRequirementDateMap
}
function calculateStockRequirement({
  stockRequirementDateMap,
  customerDCProductForecast,
}) {
  for (const key in stockRequirementDateMap) {
    for (const { date, days } of stockRequirementDateMap[key]) {
      const forecastKey = ‘${key}_${date}‘
      if (customerDCProductForecast[forecastKey]) {
        if (!customerDCProductForecast[forecastKey].stockRequirementCases) {
          customerDCProductForecast[forecastKey].stockRequirementCases = 0
        }
        for (const day of days) {
          const dayKey = ‘${key}_${day}‘
          if (customerDCProductForecast[dayKey]) {
            customerDCProductForecast[forecastKey].stockRequirementCases += (
              customerDCProductForecast[dayKey].demand
            )
          }
        }
      }
    }
  }
}
```

Method 11 includes transformation of consumption-based forecasts into a delivery forecast. Method 11 can include offsets to project timing of delivery of product into a customer's warehouse based on consumption. These are offset variables that allow the user to define when product needs to be delivered to the customer's warehouse to service a promotion on shelf. In some embodiments, method 11 can implement demand overrides.

Step 1: For each Customer Distribution Center, the system builds a forecast for each day, and the offset day from the Customer DC offset configuration:

```
while (activeDate < terminationDate) {
  if (forecastDateMap[activeDate]) {
    const key = ‘${shortCustomerDCEID}_${activeDate}‘
    deliveryOffsetMap[key] = {
      offsetDay: numberDayMap[
        (dayNumberMap[activeDate] − (offsetWeeks * 7))
      ]
    }
  }
  activeDate = numberDayMap[dayNumberMap[activeDate] + 1]
}
```

Step 2: The system uses the delivery offset map to copy the calculated consumption metrics in the base forecast into the delivery section of the base forecast using the calculated offset day.

```
if (deliveryOffsetMap[‘${cdcEID}_${day}’]) {
  const { offsetDay } = deliveryOffsetMap[‘${cdcEID}_${day}’]
  const offsetKey = ‘${rEID}_${cdcEID}_${pEID}_${offsetDay}’
  if (!baseForecast[offsetKey]) {
      initializeForecastPoint(
        key: offsetKey,
        baseForecast
      })
  }
  baseForecast[offsetKey].delivery = {
    . . . clone(baseForecast[key].consumption),
    . . . baseForecast[key].delivery
  }
```

Method 12 includes planning of initial case shipment volume for new distribution. Method 12 can include pipe-fill logic to plan an initial shelf-fill shipment. Users can define, by product group, how a retailer orders new product for resets. The parameters for planning can include a number of cases per store, a lead time and/or skip weeks. The lead time can include how long before the shelf resets the customer needs to deliver. The skip weeks can include how many weeks before the customer reorders.

This configuration can be toggled on and off on the incremental stores planned to take products.

For each Distribution Point, look through each forecast and if there is a pipe fill configuration for the retailer, see if there are any increases in store counts that require volume to be added to the forecast to support the volume needed for the new stores.

```
  if (pipeFillConfiguration) {
    for (const forecast of forecasts) {
      const { date, storeCount } = forecast
      const assignmentWeek = numberWeekMap[
        Number(weekNumberMap[date]) − Number(pipeFillConfiguration.offsetWeeks)
      ]
      if (!assignmentWeek) {
        continue
      }
      const {
        newStores,
        oldVelocity,
        listPrice
      } = getNewStoresAndOldVelocity({
        date,
        distributionPointForecasts: forecasts
      })
      if (newStores > 0) {
        const retailerEID = shortID(retailerEntityId)
        const productEID = shortID(productEntityId)
        // Populate New Distribution Date Map
        const yearHalf = getHalfFromDate(assignmentWeek)
        const newDistributionKey = ‘${retailerEID}_${productEID}_${yearHalf}‘
        // Get the assignment week or get the latest assignment week in the half
        if (
          !newDistributionDateMap[newDistributionKey] ||
          newDistributionDateMap[newDistributionKey] < assignmentWeek
        ) {
          newDistributionDateMap[newDistributionKey] = assignmentWeek
        }
        const dailyPipeFillCases = (newStores * pipeFillConfiguration.casesPerStore) /
DAYS_IN_WEEK
        // For each day in week
        let currentDate = assignmentWeek
        for (let i = 0; i <= 6; i += 1) {
          const key =
‘${shortRetailerEID}_${shortCustomerDCEID}_${shortProductEID}_${currentDate}‘
          initializeForecastPoint({
            key,
            baseForecast
          })
          const forecastPoint = baseForecast[key].delivery
          forecastPoint.pipeFillCases = dailyPipeFillCases
          forecastPoint.storeCount = storeCount
          currentDate = numberDayMap[Number(dayNumberMap[currentDate]) + 1]
        }
      }
    }
  }
```

Method 13 includes algorithmic creation of case production targets based on days-on-hand targets. Method 13 can include logic related to aggregating demand and inventory to formulate a production plan from days on hand targets.

The creation of Production Targets from days-on-hand targets is addressed in the following algorithm:

```
function calculateOrdersFromDOH({
  newPurchaseOrder,
  productToProductGroupMap,
  qaHoldTimeForecastMap,
  rollUpForecast,
  selectedProducts
}) {
  const ordersFromDOHMap = { }
  for (let product of selectedProducts) {
    const purchaseOrderProduct = newPurchaseOrder.products[product.entityId]
    if (!purchaseOrderProduct) {
      continue
    }
    const productGroupEntityId = productToProductGroupMap[product.entityId]
    let qaHoldTimeDays = 0
    if (qaHoldTimeForecastMap[productGroupEntityId]) {
      qaHoldTimeDays = getActiveForecast({
        sortedForecasts: qaHoldTimeForecastMap[productGroupEntityId],
        defaultValue: 0,
        attr: ‘holdTimeDays’
      })
    } else if (qaHoldTimeForecastMap[‘null’]) {
      qaHoldTimeDays = getActiveForecast({
        sortedForecasts: qaHoldTimeForecastMap[‘null’],
        defaultValue: 0,
        attr: ‘holdTimeDays’
      })
    }
    // Production Orders are not part of starting inventory until 1 day
    // after they are produced
    const adjustedHoldTimeDays = qaHoldTimeDays + 1
    const resolvedProductionDate = addDays({
      date: purchaseOrderProduct.productionDate,
      numberOfDays: adjustedHoldTimeDays
    })
    const forecastPoint = getValue({
      obj: rollUpForecast,
      defaultValue: null,
      attr1: resolvedProductionDate,
      attr2: product.entityId
    })
    if (!forecastPoint) {
      continue
    }
    // Ordered Cases to hit target Days on Hand
    let totalStockRequirement = 0
    let totalShrink = 0
    let currentDate = resolvedProductionDate
    const targetDaysOnHand = purchaseOrderProduct.dohAfterDelivery
    const endDate = addDays({
      date: resolvedProductionDate,
      numberOfDays: targetDaysOnHand
    })
    while (currentDate <= endDate) {
      const nextForecastPoint = getValue({
        obj: rollUpForecast,
        defaultValue: { stockRequirement: 0, shrink: 0 },
        attr1: currentDate,
        attr2: product.entityId
      })
      total StockRequirement += nextForecastPoint.stockRequirement
      totalShrink −= nextForecastPoint.shrink
      currentDate = addDays({ date: currentDate, numberOfDays: 1 })
    }
    const startingInventory = forecastPoint.startingInventory || 0
    const orderedCases = totalStockRequirement − totalShrink − startingInventory
    if (!ordersFromDOHMap[product.entityId]) {
      ordersFromDOHMap[product.entityId] = {
        orderedCases: 0
      }
    }
    ordersFromDOHMap[product.entityId].orderedCases = orderedCases
  }
  return ordersFromDOHMap
}
```

Method 14 includes algorithmic allocation of product from plants to distribution centers using days-on-hand targets. Method 14 can include logic related to aggregating demand and inventory to formulate an ideal stock allocation from plants to inbound warehouses.

The following algorithm uses the current days on hand value calculated for each Manufacturer Distribution Center, and the available inventory at the plant to determine where and how much product should be deployed to each Distribution Center.

```
let indexCounter = 1
for (const productEntityId in autoAllocationMap) {
  const {
    startingQuantity,
    total AllocatedCases,
    totalInventoryDelta,
    manufacturerDCs
  } = autoAllocationMap[productEntityId]
  const quantityToAllocate = startingQuantity − totalAllocatedCases
  const palletFactor = palletFactorMap[productEntityId]
  let palletsRemaining = 0
  if (palletFactor > 0) {
    palletsRemaining = Math.floor(quantityToAllocate / palletFactor)
  }
  // Manufacturer DCs which round down to 0 pallets, but have a partial allocation
  const overflowAllocation = [ ]
  for (const manufacturerDCEntityId in manufacturerDCs) {
    const existingDeploymentKey = mdcToDeploymentMap[manufacturerDCEntityId]
    const { inventoryDelta } = manufacturerDCs[manufacturerDCEntityId]
    let allocationProportion = 0
    if (totalInventoryDelta < 0 && inventoryDelta < 0) {
      allocationProportion = inventoryDelta / totalInventoryDelta
    }
    const mdcPortionOfQuantity = quantityToAllocate * allocationProportion
    // Only allocate pallets, not cases during auto-allocation
    let palletsToAllocate = 0
    if (palletFactor > 0) {
      pallets ToAllocate = Math.floor(mdcPortionOfQuantity / palletFactor)
      // Allocate any leftover pallets here
      if (palletsToAllocate === 0 && mdcPortionOfQuantity > 0) {
        overflowAllocation.push(manufacturerDCEntityId)
      }
    }
    // Modify deployments if there is an allocation to be made
    if (palletsToAllocate > 0) {
      palletsRemaining −= palletsToAllocate
      // Update existing deployment if one exists
      if (
        existingDeploymentKey &&
        existingDeployments[existingDeploymentKey]
      ) {
        const key = existingDeploymentKey
        // Whether the product has been created on the deployment yet
        const existingPalletsAllocated = existingDeployments[key].products[
          productEntityId
        ]
          ? existingDeployments[key].products[productEntityId]
              .palletsAllocated.value
          : 0
        const resolvedPallets = existingPalletsAllocated + palletsToAllocate
        const updatedDeployment = {
          ...existingDeployments[key],
          products: {
            ...existingDeployments[key].products,
            [productEntityId]: {
              ...defaultProductControls,
              ...existingDeployments[key].products[productEntityId],
              palletsAllocated: {
                value: String(resolvedPallets),
                isValid: true,
                isEditing: true
              }
            }
          }
        }
        existingDeployments[key] = updatedDeployment
      } else {
        // Create a new deployment
        // Ensure unique index
        const key = Date.now( ) + indexCounter
        indexCounter += 1
        const { dateKey, plantEntityId } = forecastPoint || {
          dateKey: ‘’,
          plantEntityId: ‘’,
        }
        let defaultArrivalDate = ‘’,
        if (dateKey) {
          defaultArrivalDate = addDays({ date: dateKey, numberOfDays: 1 })
        }
        const newDeployment = {
          ...
          products: {
            [productEntityId]: {
              palletsAllocated: {
                value: palletsToAllocate,
              }
        }
        // Mark as primary deployment
        mdcToDeploymentMap[manufacturerDCEntityId] = key
        existingDeployments[key] = newDeployment
      }
    }
  }
  // Allocate remaining pallets here
  if (overflowAllocation.length > 0) {
    while (palletsRemaining > 0) {
      for (const manufacturerDCEntityId of overflowAllocation) {
        const key = mdcToDeploymentMap[manufacturerDCEntityId]
        let resolvedPallets = 1
        if (key && existingDeployments[key]) {
          if (
            existingDeployments[key].products[productEntityId] &&
            existingDeployments[key].products[productEntityId]
              .palletsAllocated
          ) {
            resolvedPallets =
              Number(
                existingDeployments[key].products[productEntityId]
                  .palletsAllocated.value
              ) + 1
          }
          const updatedDeployment = {
            ...existingDeployments[key],
            products: {
              ...existingDeployments[key].products,
              [productEntityId]: {
                ...defaultProductControls,
                ...existingDeployments[key].products[productEntityId],
                palletsAllocated: {
                  value: String(resolvedPallets),
                  isValid: true,
                  isEditing: true
                }
              }
            }
          }
          existingDeployments[key] = updatedDeployment
        } else {
          // Create a new deployment
          // Ensure unique index
          const key = Date.now( ) + indexCounter
          indexCounter += 1
          const { dateKey, plantEntityId } = forecastPoint || {
            dateKey: ‘’,
            plantEntityId: ‘’
          }
          let defaultArrivalDate = ‘’
          if (dateKey) {
            defaultArrivalDate = addDays({ date: dateKey, numberOfDays: 1 })
          }
          const newDeployment = {
              products: {
              [productEntityId]: {
                pallets Allocated: {
                  value: resolvedPallets,
                },
              }
          }
          // Mark as primary deployment
          mdcToDeploymentMap[manufacturerDCEntityId] = key
          existingDeployments[key] = newDeployment
        }
        palletsRemaining −= 1
        // Exit while loop if finished allocating inventory
        if (palletsRemaining < 1) {
          break
        }
      }
    }
  }
}
```

Method 15 includes planning of retail shipper volume. Method 15 can include the ability to create a nested product that contains units of one or many different products and apply this to a planned promotion in the disclosed method. Shippers, or special cases, are then apportioned evenly across the promotion period in the consumption forecast and, in the delivery forecast planned to deliver completely at the start of the promotion.

Shipper Volume is spread over the days duration of the promotion it is attached to if we are calculating a consumption forecast, otherwise if we are calculating a delivery forecast all volume is put in the first day of the promotion.

The below function shows how the system transforms forecasted shippers into an intermediary forecast, allowing these shippers to be applied to a base forecast, other intermediary forecasts, or a domain forecast.

```
function constructShipperForecastMap({
  type,
  productGroups,
  shippers,
  distributionPoints,
  promotionForecasts
}) {
  // 1. Extract Shipper Forecasts from Promotion Forecasts
  const shippersMap = { }
  let shipperProductEntityIds = [ ]
  for (let entityId in promotionForecasts) {
    .... Extract the shippers planned on promotion forecasts
}
  // 2. Construct store count map for allocating shipper volume
  // Retailer / Product / { distribution points }
  const distributionPointMap = { }
  for (let entityId in distributionPoints) {
    ....
  }
  // 3. Allocate Shipper units by proportion of customer dc store counts for retailer/product
  // distribution points
  const shipperForecastMap = { }
  for (let shipper of Object.values(shippersMap)) {
    // Create Allocation Map
    // Product / Week / total StoreCount, CDC { storeCount }
    const allocationMap = { }
    for (let { productEntityId } of shipper.products) {
      const distributionPoints = getValue({
        obj: distributionPointMap,
        defaultValue: null,
        attr1: retailerEntityId,
        attr2: productEntityId
      })
    }
    // Create Proportion Map
    const proportionMap = { }
    for (let productEntityId in allocationMap) {
          if (totalStoreCount > 0) {
            const { storeCount } = allocationMap[productEntityId][day][
              cdcEntityId
            ]
            const weight = storeCount / total StoreCount
            proportionMap[productEntityId][day][cdcEntityId] = weight
    }
    const { shipperQuantity } = shipper
    // All shipper volume is placed in start date for delivery,
    // and evenly spread for consumption forecast
    if (type === ‘DELIVERY’) {
        for (let day of shipper.daysOnPromotion) {
          if (day === shipper.startDate) {
                shipperForecastMap[retailerEntityId][cdcEntityId][
                  productEntityId
                ][day].shipperCost += adjustedCost
            }
        }
      }
    } else {
      for (let product of shipper.products) {
        const { productEntityId, proportionalCost } = product
        const dailyShipperProductCost =
          (proportional Cost * shipperQuantity) / shipper.daysOnPromotion.length
        for (let day of shipper. daysOnPromotion) {
              shipperForecastMap[retailerEntityId][cdcEntityId][
                productEntityId
              ][day].shipperCost += adjustedCost
      }
    }
  }
  return shipperForecastMap
}
```

Method 16 includes algorithmic forecasting of retail sales cannibalization. Method 16 can include Users loading in incrementality curves for each of their planned retailers. Incrementality curves are defined as the percent of incremental sales a new item brings to the assortment. As brands increase the number of products on shelf, the odds that a new product will steal sales from another existing product increases. The method can include cannibalization features that can enable the user to create auto-generated forecast points when new items are slated to come onboard to capture cannibalization. Exemplary calculation of retail sales cannibalization can be the following:

```
const { getActiveForecast } = require(‘../../utilities/access’)
const { sortAscending } = require(‘../../utilities/list’)
function calculateCannibalization({
  distributionPoints,
  retailerCannibalizationConfigurations,
  products
}) {
  // Prepare Distribution Points by sorting forecasts
  const distributionPointsMap = { }
  for (let key in distributionPoints) {
    const distributionPoint = distributionPoints[key]
    distributionPoint.key = key
    distributionPoint.forecasts = sortAscending(
      distributionPoint.forecasts,
      ‘date’
    )
    const firstForecast = distributionPoint.forecasts[0]
    distributionPoint.firstForecast = firstForecast
    distributionPoint.firstForecastDate = firstForecast.date
    distributionPointsMap[key] = distributionPoint
  }
  const sortedConfigurations = sortAscending(
    Object.values(retailerCannibalizationConfigurations),
    ‘numberOfProducts’
    )
  const sortedDistributionPointsList = sortAscending(
    Object.values(distributionPointsMap),
    ‘firstForecastDate’
  )
  // Capture when products start distribution at a Retailer
  // New Products only.
  // { <Date>: [Unique Product Entity Ids] }
  const newDistributionCalendar = { }
  const distributionPointCalendar = { }
  for (let distributionPoint of sortedDistributionPointsList) {
    const { productEntityId, firstForecastDate } = distributionPoint
    if (!distributionPointCalendar[firstForecastDate]) {
      distributionPointCalendar[firstForecastDate] = [ ]
    }
    distributionPointCalendar[firstForecastDate].push(distributionPoint)
    if (!newDistributionCalendar[firstForecastDate]) {
      newDistributionCalendar[firstForecastDate] = [ ]
    }
    if (
      newDistributionCalendar[firstForecastDate].includes(productEntityId) ===
      false
    ) {
      newDistributionCalendar[firstForecastDate].push(productEntityId)
    }
  }
  // Captures the number of products being sold, at each date where there
  // is new Distribution Starting
  // { <Date>: <Number of Products }
  // For Example { ‘2017-12-31’: 1, ‘2018-01-07’: 2 }
  const productMixCalendar = { }
  let currentAssortmentCount = 0
  // Ensure Dates in chronological order
  const growthDates = Object.keys(newDistributionCalendar).sort( )
  for (let date of growthDates) {
    const newProducts = newDistributionCalendar[date].length
    const total Assortment = currentAssortmentCount + newProducts
    productMixCalendar[date] = totalAssortment
    currentAssortmentCount += newProducts
  }
  // Captures the related Retailer % Incremental Sales configuration
  // corresponding to the Product Mix at that time (sourced from Product Mix Calendar)
  // { <Date>: <Number (% of Incremental Sales)> }
  const percentIncremental SalesCalendar = { }
  for (let date in productMixCalendar) {
    const numberOfProducts = productMixCalendar[date]
    const percentIncrementalSales = getActivePercentIncrementalSales({
      numberOfProducts,
      sortedConfigurations
    })
    percentIncrementalSalesCalendar[date] = percentIncrementalSales
  }
  const activeDistributionPoints = { }
  // This Change Set is what gets returned to be applied to existing distribution points
  const distributionPointChangeSet = { }
  for (let date in distributionPointCalendar) {
    // 1. Calculate incremental velocity for this
    // set of Distribution Points
    let totalVelocity = 0
    let incrementalVelocity = 0
    const cannibalizingDistributionPoints = [ ]
    for (let distributionPoint of distributionPointCalendar[date]) {
      cannibalizingDistributionPoints.push(distributionPoint)
      const activeForecast = getActiveForecast({
        sortedForecasts: distributionPoint.forecasts,
        date,
        defaultValue: { velocity: 0 }
      })
      const velocity = Number(activeForecast.velocity)
      const percentIncrementalSales = percentIncrementalSalesCalendar[date]
      const incrementalSalesDecimal = percentIncrementalSales / 100
      let adjustedVelocity = velocity
      if (Object.keys(activeDistributionPoints).length > 0) {
        adjustedVelocity = velocity * incrementalSalesDecimal
      }
      totalVelocity += velocity
      incrementalVelocity += adjustedVelocity
    }
    const cannibalizedUnitsReduction = totalVelocity − incrementalVelocity
    const cannibalizingDistributionPointKeys = cannibalizingDistributionPoints.map(
      distPt => {
        return distPt.key
      }
    )
    const cannibalizingProducts = cannibalizingDistributionPoints.reduce(
      (acc, cur) => {
        const { productEntityId } = cur
        if (!acc.includes(productEntityId)) {
          acc.push(productEntityId)
        }
        return acc
      },
      [ ]
    )
    /* Calculate Velocity Map
        This captures the velocity at the respective Distribution Point start Date
        (When the product first starts selling on shelf), and any associated
        Product Cannibalization modifier
        {
          <Product Entity Id>: {
            velocity: Number,
            productCannibalizationPercent: Number
          }
        }
    */
    const velocityMap = { }
    let activeTotalVelocity = 0
    for (let activeDistributionPoint of Object.values(
      activeDistributionPoints
    )) {
      // Do not cannabilize the Product doing the cannabilzing
      const newKey = activeDistributionPoint.key
      if (cannibalizingDistributionPointKeys.includes(newKey)) {
        continue
      }
      const { productEntityId, forecasts } = activeDistributionPoint
      // Capture Product Cannibalization multiplier
      let productCannibalizationPercent = 0
      let cannibalizingModifiers = 0
      for (let cannibalizingProductEntityId of cannibalizingProducts) {
        if (
          products[cannibalizingProductEntityId] &&
          products[cannibalizingProductEntityId].cannibalizationConfigurations[
            productEntityId
          ]
        ) {
          // Combine all cannibalization modifiers for this Distribution
          // Points product
          const modifierPercent =
            products[cannibalizingProductEntityId]
              .cannibalizationConfigurations[productEntityId].modifierPercent
          productCannibalizationPercent += modifierPercent
          cannibalizingModifiers += 1
        }
      }
      if (cannibalizingModifiers > 0) {
        productCannibalizationPercent =
          productCannibalizationPercent / cannibalizingModifiers
      }
      // Get Active Store Count and velocity for existing Distribution
      // Point
      const activeExistingForecast = getActiveForecast({
        sortedForecasts: forecasts,
        date,
        defaultValue: { storeCount: 0, velocity: 0 }
      })
      const storeCount = Number(activeExistingForecast.storeCount)
      const velocity = Number(activeExistingForecast.velocity)
      // Do not modify Existing Distribution Points that do not have
      // active volume
      const existing Volume = velocity * storeCount
      if (existingVolume === 0) {
        continue
      }
      velocityMap[newKey] = {
        velocity,
        productCannibalizationPercent
      }
      activeTotalVelocity += velocity
    }
    // Determine which Distribution Points should have their velocity reduced
    // (cannibalized)
    // { <Distribution Point Key>: Number (Units to reduce velocity by) }
    const velocityReductionMap = { }
    for (let key in velocityMap) {
      const { velocity, productCannibalizationPercent } = velocityMap[key]
      let velocityReduction = 0
      if (totalVelocity > 0) {
        // Calculate cannibalization units to reduce
        velocityReduction =
          (velocity / activeTotalVelocity) * cannibalizedUnitsReduction
        // Modify by product cannibalization factor
        velocityReduction =
          (1 + productCannibalizationPercent / 100) * velocityReduction
      }
      velocityReductionMap[key] = velocityReduction
      if (!distributionPointChangeSet[key]) {
        distributionPointChangeSet[key] = { }
      }
      distributionPointChangeSet[key][date] = {
        date,
        velocityAdjustment: −velocityReduction
      }
    }
    // Update Active Distribution Points, for next calculation iteration
    for (let distributionPoint of distributionPointCalendar[date]) {
      activeDistributionPoints[distributionPoint.key] = distributionPoint
    }
  }
  return distributionPointChangeSet
}
function getActivePercentIncrementalSales({
  numberOfProducts,
  sortedConfigurations
}) {
  let active Value = 0
  for (let config of sortedConfigurations) {
    if (config.numberOfProducts > numberOfProducts) {
      break
    }
    activeValue = config.percentIncrementalSales
  }
  return activeValue
}
```

Method 17 includes apportionment of gross sales of delivered product to underlying retailer accounts. When Gross sales comes from an Order, the system is able to use the ‘Retailer Proportion Map’ (a forecast where the distribution points by Customer Distribution Center/Product/Week Date map to the proportion of Retailers receiving volume from the Distribution Center, by the total volume supplied by the Distribution Center). For example, the map may look like this:

```
<Customer Distribution Center 1 / Product 1 / Week Date 1> {
  <Retailer 1>: .25
  <Retailer 2>: .5
  <Retailer 3>: .25
}
```

Where Customer Distribution Center 1 ships Product 1 to the following Retailers as of Week Date 1: Retailer 1: 250 units, Retailer 2: 500 units, Retailer 3: 250 units. The system uses the proportions to allocate Gross sales to the retailer level for our dynamic forecasting as the best approximation possible where in the real world, there is no direct mapping between the volume purchased and brought into the Distribution Center and the units sold off the Retailer store shelf.

Method 18 includes algorithmic identification of baseline and promotional sales weeks. The identification of baseline and promotion sales weeks involves a specific algorithm. The system calculates the Refinement Forecast which brings together the bottom-up forecast metrics, including forecasted units, active store count, forecasted price point, and actual price point. Then the system compares the active price point with the everyday price point to see if a promotion is active or not.

```
//1. For each week in the refinement timeframe, if there is an actual price point
// and scan units, then aggregate the scan units and count the number of weeks where
// the actual price is within the threshold of the base price (Resolved EDLP Price).
// When the actual price and base price are within the threshold, we can assume that
// it is a base price, not a promoted price point.
let weightedUnitsSold = 0
let numberOfWeeks = 0
let needsEverydayPrice = false
for (const date in forecastRefinement.forecast) {
  const { units, storeCount, pricePoint } = forecastRefinement.forecast[
    date
  ]
  if (pricePoint.actual !== 0 && units.scan > 0) {
    // const average = (pricePoint.resolvedEverydayPrice + pricePoint.actual) / 2
    const difference =
      pricePoint.resolvedEverydayPrice − pricePoint.actual
    if (pricePoint.resolvedEverydayPrice !== 0) {
      const change =
        (difference / pricePoint.resolvedEverydayPrice) * 100
      if (change <= Number(percentThreshold)) {
        weightedUnitsSold += units.scan
        numberOfWeeks += 1
        if (change < −Number(percentThreshold)) {
          needsEverydayPrice = true
        }
      }
    }
  }
}
```

Method 19 includes algorithmic management of forecasted baseline and promotional sales volume.

Method 20 includes algorithmic forecasting of case shipment sales derived from customer inventories.

Method 21 includes an advantageous architecture. The architecture can be a server-first architecture which uses micro-services to run server-side calculations versus an alternative architecture which employs client-side calculations. This architecture is set forth above in the present disclosure.

Method 22 includes integration of demand, trade promotion, supply, and order planning. Integration of Demand, Trade, Supply, Promotion Planning, and Order Management are set forth in previous sections.

Method 23 includes algorithmic creation of distribution maps and velocity using observed data.

### Approach for Efficient and Connected Forecasting

Definitions include the following.

A Domain Forecast is a Forecast Chain.

A Forecast Chain is a sequence of Forecast Chain Links, deliberately ordered and passed the appropriate variables.

A Forecast Chain Link is a specific piece of forecast functionality (calculating a value, arranging some data for future processing, etc.) that takes specific inputs, produces specific outputs, and expects to be run at a particular time in the Forecast Chain.

The particularity of the Chain allows us to keep the Chain as performant as possible, and only perform a calculation once and used wherever else down the chain it is needed.

The system examines the Settings and Data Map and create Selections and Forecast Maps for only the settings and data passed in. That way, the system can call the same Selections and Forecast Map construction functions in all domain forecasts.

### Domain Forecast Calculation Approach

Get Selections
   The system takes the ‘settings’ and transform them into ‘selections’. The settings are ‘Products’ to be selected
Construct Forecast Map
   Transform the Data Map into a Forecast Map, which is the underlying data in the data map structured for efficient processing by our forecast algorithm. For example, the system will transform our collection of Distribution Points
Construct Forecast
   For each Product, the system calculates a base forecast, and aggregate the additive metrics to an intermediate or domain forecast. This is how the system keeps the base forecast from taking up too much memory. Build it up one Product at a time, and aggregate the additive metrics to the domain forecast(s).
   After the Base Forecast is fully constructed, construct any intermediary forecasts needed, at a higher level of granularity. (Like Retailer Product Forecast, Customer DC Product Forecast, etc.)
   Calculate Non-Additive Metrics, or metrics that require multiple Calculation Passes
      A Calculation Pass is a single collection traversal to perform some modifying action on the collection being traversed.
      Ideally, Collection Passes are grouped where they can be used logically in different domain forecasts, but also traverse the collection as few times as needed.
         Constructing a Domain Forecast from a Base/Intermediate Forecasts

The following is an example of how the system uses forecast chains to construct domain forecasts from source data. The below algorithm's both balance the maximum speed and memory efficiency to construct forecasts of varying sizes.

```
function constructDomainForecast({ settings, dataMap }) {
  const selections = getSelections({ settings, dataMap })
  const forecastMap = constructForecastMap({ settings, selections, dataMap })
  const forecast = constructForecast({
      settings,
      selections,
      forecastMap,
      dataMap
  })
  return forecast
}
function constructForecast(
  { settings, selections, forecastMap, dataMap },
) {
    // Domain forecast to have a base forecast aggregated into.
    const forecast = { }
    // Construct Base Forecast one Product at a time for memory efficiency.
    for (const productEntityId of selections.selectedProductEntityIds) {
      const baseForecast = { }
      // { Retailer_Product: <Pipe Fill Date> }
      const newDistributionDateMap = { }
      // Baseline and foundation
      const distributionPoints = get Value({
        obj: forecastMap.distributionPointMap,
        defaultValue: { },
        attr1: productEntityId
      })
      applyBaseline({
        dayToWeekMap: forecastMap.dayToWeekMap,
      dayNumberMap: forecastMap.dayNumberMap,
        numberDayMap: forecastMap.numberDayMap,
        weekNumberMap: forecastMap.weekNumberMap,
        numberWeekMap: forecastMap.numberWeekMap,
        earliestStartDate,
        latestEndDate,
        forecastDateMap,
        retailers: dataMap.retailers,
        productToProductGroupMap: forecastMap.productToProductGroupMap,
        distributionPoints,
        baseForecast,
        newDistributionDateMap,
      })
      // Attributes
      // Retailer Attributes
      // Product Attributes
      // Retailer Product Attributes
      applyAttributes({
        baseForecast,
        dayToWeekMap: forecastMap.dayToWeekMap,
        productForecastMap: forecastMap.productForecastMap,
        retailerForecastMap: forecastMap.retailerForecastMap,
        retailerProductForecastMap: forecastMap.retailerProductForecastMap,
      })
      // Customer DC / Product / Week = { Retailer: <Proportion> }
      const retailerProportionMap = { }
      // Retailer / Product / Week = { Customer DC: <Proportion> }
      const customerDCProportionMap = { }
      // Retailer / Customer DC / Week = { Product: <Proportion> }
      const productProportionMap = { }
      // Delivery Offset
      applyDeliveryOffset({
        baseForecast,
        retailerProportionMap,
        customerDCProportionMap,
        productProportionMap,
        dayToWeekMap,
        deliveryOffsetMap: forecastMap.deliveryOffsetMap
      })
      // Promotions Running
      const allPromotionForecasts = get Value({
        obj: forecastMap.allPromotionForecastMap,
        defaultValue: { },
        attr1: productEntityId
      })
      applyRunningPromotions({
        baseForecast,
        customerDCProportionMap,
        dayNumberMap: forecastMap.dayNumberMap,
        numberDayMap: forecastMap.numberDayMap,
        dayToWeekMap,
        promotionForecasts: allPromotionForecasts
      })
      // Promotion Volume
      const promotionForecasts = get Value({
        obj: forecastMap.promotionForecastMap,
        default Value: { },
        attr1: productEntityId
      })
      applyPromotionVolume({
        baseForecast,
        customerDCProportionMap,
        dayNumberMap: forecastMap.dayNumberMap,
        numberDayMap: forecastMap.numberDayMap,
        dayToWeekMap,
        promotionForecasts
      })
      // Shippers
      const shipperForecasts = getValue({
        obj: forecastMap.shipperForecastMap,
        defaultValue: { },
        attr1: productEntityId
    })
      applyShippers ({
        baseForecast,
        customerDCProportionMap,
        dayNumberMap: forecastMap.dayNumberMap,
        numberDayMap: forecastMap.numberDayMap,
        dayToWeekMap,
        shipperForecasts
      })
      // Slotting Funding
      const slottingFeeForecasts = get Value({
        obj: forecastMap.slottingFeeForecastMap,
        defaultValue: { },
        attr1: productEntityId
      })
      applySlottingFees ({
        baseForecast,
        customerDCProportionMap,
        productProportionMap,
        dayNumberMap: forecastMap.dayNumberMap,
        numberDayMap: forecastMap.numberDayMap,
        dayToWeekMap,
        newDistributionDateMap,
        slottingFeeForecasts
      })
      // Orders
      applyOrders({
        baseForecast,
        retailerProportionMap,
        shipperProportionMap: forecastMap.shipperProportionMap,
        dayNumberMap: forecastMap.dayNumberMap,
        numberDayMap: forecastMap.numberDayMap,
        weekNumberMap: forecastMap.weekNumberMap,
        numberWeekMap: forecastMap.numberWeekMap,
        earliestStartDate,
        latestEndDate,
        retailers: dataMap.retailers,
        productToProductGroupMap: forecastMap.productToProductGroupMap,
        orders: dataMap.orders
      })
      // Scans
      const scans = get Value({
        obj: forecastMap.scansMap,
        defaultValue: { },
        attr1: productEntityId
      })
      applyScans({
        baseForecast,
        customerDCProportionMap,
        dayNumberMap: forecastMap.dayNumberMap,
        numberDayMap: forecastMap.numberDayMap,
        weekNumberMap: forecastMap.weekNumberMap,
        numberWeekMap: forecastMap.numberWeekMap,
        scans,
      })
      // Demand Overrides
      const demandOverrides = getValue({
        obj: forecastMap.demandOverrideMap,
        defaultValue: { },
        attr1: productEntityId
      })
      applyDemandOverrides({
        dayNumberMap: forecastMap.dayNumberMap,
        numberDayMap: forecastMap.numberDayMap,
        palletFactorMap: forecastMap.palletFactorMap,
        baseForecast,
        demandOverrides
      })
      // Resolve Volume and Gross Sales
      calculateVolumeTotals({
        baseForecast,
      })
      // Promotion Funding
      calculatePromotionFunding({
        baseForecast,
        promotionForecastMetrics,
        customerDCProportionMap,
        dayNumberMap: forecastMap.dayNumberMap,
        numberDayMap: forecastMap.numberDayMap,
        dayToWeekMap,
        promotionForecasts
      })
      // Calculate First Pass Metrics
      calculateFinalPassMetrics({
        baseForecast,
        romotionForecastMetrics
      })
      // Construct Domain Forecast from Base Forecast
      for (const key in baseForecast) {
        const [rEID, cdcEID, pEID, date] = key.split(‘_’)
        const basePoint = baseForecast[key]
        const productEntityId = productEIDMap[pEID]
        const productGroupEntityId = productToProductGroupMap[productEntityId]
        const pgEID = shortID(productGroupEntityId)
        let forecastDates = forecastDateMap[date] || [ ]
        for (const forecastDate of forecastDates) {
          const forecastPoint = getForecastPoint({
            granularity,
            rEID,
            pgEID,
            pEID,
            forecastDate,
            forecast
          })
          applyToForecastPoint({
            forecastPoint,
            basePoint
          })
        }
      }
      // Calculate Non-Additive metrics on domain forecast
      for (const date in forecast) {
          for (const EID in forecast[date]) {
              for (const EID2 in forecast[date][EID]) {
              const forecastPoint = forecast[date][EID][EID2]
                if (forecastPoint.forecastedUnits !== 0) {
                    forecastPoint.activePricePoint += (
                      forecastPoint.weightedActivePricePoint / forecastPoint.forecastedUnits
                      )
                }
                // Trade Rate Exclusive
                const tradeRateExclusive = calculateTradeRateExclusive({
                  grossSales: forecastPoint.grossSales,
                  tradeFundingExclusive: forecastPoint.tradeFundingExclusive
                })
                forecastPoint.tradeRateExclusive = tradeRateExclusive
              }
            }
        }
    }
// Return final forecast
return forecast
```

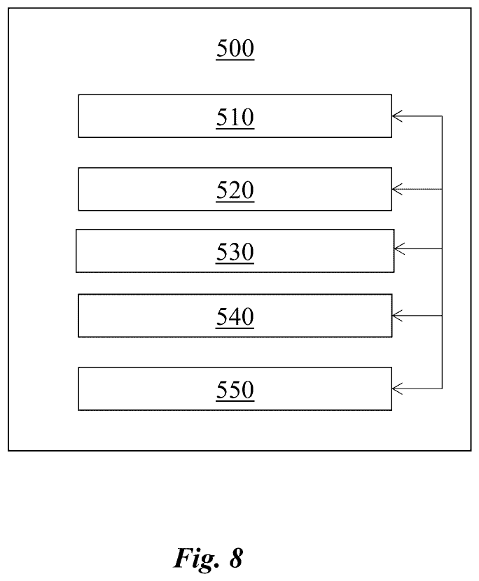

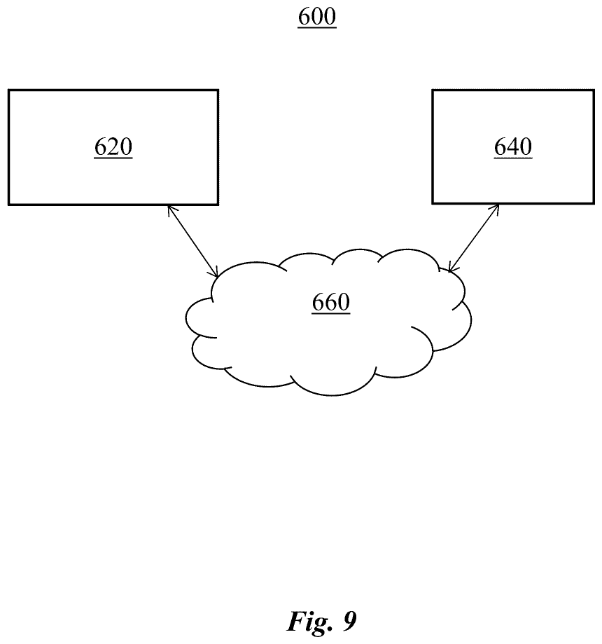

Turning to FIG. 8, an exemplary system 500 for managing CPG is shown. The system 500 can be configured to function as a server computer 640 (shown in FIG. 9) or a client-side computer 620 (shown in FIG. 9). The system 500 can include a processor 510. The processor 510 can include one or more general-purpose and/or special-purpose microprocessors (for example, single or multi-core processors), application-specific integrated circuits, application-specific instruction-set processors, graphics processing units, physics processing units, digital signal processing units, coprocessors, network processing units, encryption processing units, and the like. The system 500 can be configured to function as a server for providing user computers with access to the disclosed platform, over a computer network. Additionally and/or alternatively, the system 500 can be configured to function as a user computer used by an operator associated with one of the functions 100 (shown in FIG. 1), and/or an activity thereof.

As shown in FIG. 8, the system 500 can include one or more additional hardware components as desired. Exemplary additional hardware components include, but are not limited to, a memory 520 (alternatively referred to herein as a non-transitory computer readable medium). Exemplary memory 520 can include, for example, random access memory (RAM), static RAM, dynamic RAM, read-only memory (ROM), programmable ROM, erasable programmable ROM, electrically erasable programmable ROM, flash memory, secure digital (SD) card, and/or the like. Instructions for implementing the system 500 can be stored on the memory 520 to be executed by the processor 510.

Additionally and/or alternatively, the system 500 can include a communication module 530. The communication module 530 can include any conventional hardware and software that operates to exchange data and/or instruction between the system 500 and another computer system (not shown) using any wired and/or wireless communication methods. For example, the system 500 can receive the data stream 400 (shown in FIG. 6) from another computer system via the communication module 530. Exemplary communication methods include, for example, radio, Wireless Fidelity (Wi-Fi), cellular, satellite, broadcasting, or a combination thereof.

Additionally and/or alternatively, the system 500 can include a display device 540. The display device 540 can include any device that operates to presenting programming instructions for operating the system 500, and/or presenting data in the interfaces 220, 240, 260 (shown in FIGS. 4, 5 and 7). Additionally and/or alternatively, the system 500 can include one or more input/output devices 550 (for example, buttons, a keyboard, keypad, trackball), as desired.

The processor 510, the memory 520, the communication module 530, the display device 540, and/or the input/output device 550 can be configured to communicate, for example, using hardware connectors and buses and/or in a wireless manner.

Turning to FIG. 9, an operation environment 600 is shown as including at least one client-side computer 620. The client-side computer 620 can include a device or system with which a user can visit an information source, such as a web page and/or operating an app. Exemplary client-side computer 620 can include a computer, a personal computer (PC) and/or a mobile computer device, such as a tablet computer and/or a smart phone.

The client-side computers 620 can be configured to operate a web app (not shown). The app can receive information from a server computer 640 and present the information via a graphical user interface (for example, shown in FIGS. 4, 5 and 7).

The server computer 640 can include one or more computer systems for implementing functions as set forth above in various embodiments. In some embodiments, the server computer 640 can solely perform at least one of the methods as disclosed above. In other embodiments, the method can at least partially be implemented on the client-side computer 620, such that the server computer 640 and the client-side computer 620 can collectively implement the method. In yet other embodiments, the client-side computer 620 can solely perform the method.

The server computer 640 and/or the client-side computer 620 can communicate via a communication network 660. The communication network 660 can support wired and/or wireless communication between the server computer 640 and the client-side computer 620. Exemplary communication networks 660 can include, but are not limited to, a local area network (LAN), a wide area network (WAN), a corporate intranet, the Internet, a wireless network, a cellular network, and/or other networks that use radio, Wireless Fidelity (Wi-Fi), satellite, and/or broadcast communications.

Although FIG. 9 shows the operation environment 600 as including one server computer 640, one client-side computer 620 and one communication network 660 for illustrative purposes only, the operation environment 600 can include any number of uniform and/or different server computers 640 and/or client-side computers 620. The server computer 640 and/or the client-side computer 620 can communicate with each other via uniform and/or different networks 600.

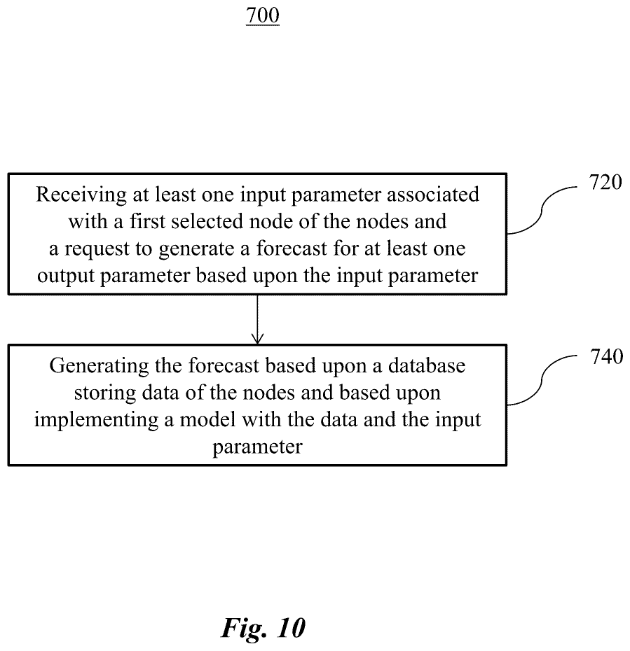

Turning to FIG. 10, a method 700 for managing CPG is shown. The method 700 can be implemented at a plurality of nodes (not shown) of supplying a product. The node can include any junction(s), stage(s), and/or connecting point(s) within a supply chain ranging from a plant for manufacturing the product to a retail store for selling the product to consumers. For example, the node can include a retailer store, all retail stores in the supply chain of the product, and/or a subset of multiple retail stores. In another example, the node can include a customer DC, all customer DCs in the supply chain, and/or a subset of multiple customer DCs. In yet another example, the node can include a manufacturer DC, all manufacturer DCs in the supply chain, and/or a subset of multiple manufacturer DCs. In yet another example, the node can include a plant, all plants in the supply chain, and/or a subset of multiple plants. Identify and/or definition of the node can be based upon a specific aspect of interest in the product planning.

In various embodiments, the method 700 can be implemented by the server computer 640 (shown in FIG. 9). According to the method 700, the server computer 640 can receive, at 720, at least one input parameter associated with a first selected node of the nodes, and a request to generate a forecast for at least one output parameter based upon the input parameter. The input parameter can include a parameter related to a proposal, plan or actual event related to supply chain planning and/or product selling. In a non-limiting example, the input parameter can include an amount of products that are supplied and/or demanded at the node, lead time at the node, financial metrics, and/or other conditions as needed to generate a forecast and/or analysis related to the supply chain and/or product selling activities. The output parameter can include a parameter related to a future scenario related to supply chain planning and/or product selling. The future scenario can result from implementing the input parameter. In a non-limiting example, the output parameter can include an amount of products that are to be supplied and/or demanded at the node, financial metrics, and/or other conditions indicating an effect of the input parameter on the supply chain planning and/or product selling.

The forecast can be generated, at 740, based upon a database storing data of the nodes and based upon implementing a model with the data and the input parameter. The database and the model are in accordance with various embodiments above. The forecast can be made for any suitable type of information (for example, output parameter that is indicative of, or a part of, a future scenario), and/or analysis results, related to planning of the product. Stated somewhat differently, the forecast can include an anticipation of event, a conjectural estimate or account, based on input parameters and/or scenarios, of the course of events or state of supply chain in the future. In a non-limiting example, the forecast can include predicting data, setting target to reach at a node, simulating scenarios, and/or indicating potential actions to achieve optimization or goal. The server computer 640 can also generate other suitable type of analysis results, without limitation. For example, the server computer 640 can receive actual data, and/or comparing the actual data with predicted data.

In some embodiments, a method is disclosed for managing consumer packaged goods (CPG), comprising: obtaining data associated with a plurality of functions of an entity managing a product, the functions each being implemented at a selected stage of the product, the product being a type of the CPG; and implementing an activity of a selected function of the functions based upon said obtaining.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A computer-implemented method for web-based management of consumer packaged goods (CPG) at a plurality of nodes of supplying a product, the product being a type of the CPG, the method comprising:
receiving, by a computing system:
at least one input parameter associated with a first selected node of the nodes; and
a request to generate a forecast for at least one output parameter based upon the input parameter; and
generating, by the computing system, the forecast based upon a database storing data of the nodes and based upon implementing a model with the data and the input parameter.

2. The method of claim 1, wherein the nodes include at least one retailer banner for selling the product, at least one retail store for selling the product, at least one manufacturer distribution center (DC), at least one customer DC, at least one plant manufacturing the product, or a combination thereof.

3. The method of claim 1, wherein the output parameter being associated with a second selected node of the nodes, the second selected node being upstream relative to the first selected node.

4. The method of claim 3, wherein the first selected node includes a retail store and the second selected node includes a customer DC supplying the product to the retail store.

5. The method of claim 3, wherein the input parameter includes a supply of the product to the second selected node, and the output parameter includes a predicted supply of the product assigned to the first selected node from the second selected node.

6. The method of claim 3, wherein:
said receiving further includes receiving an offset including an operational lead time between the first and second selected nodes;
the input parameter includes a predicted demand at the first selected node;
the output parameter includes a predicted demand at the second selected node; and
said generating is further based upon the offset.

7. The method of claim 3, wherein the input parameter includes one or more pipe-fill configuration parameters of the first selected node, wherein the output parameter includes a predicted demand of the product at the second selected node.

8. The method of claim 7, wherein the pipe-fill configuration parameters include an offset time including an operational lead time between the first and second selected nodes, and an amount of the product required for a new launch of the product at the first selected node.

9. The method of claim 3, wherein the input parameter includes one or more promotion lift parameters of the first selected node, wherein the output parameter includes a predicted demand of the product at the second selected node.

10. The method of claim 9, wherein the promotion lift parameters include an increase of sale of the product at the first selected node and associated with a trade promotion.

11. The method of claim 1, wherein the input parameter includes at least one proposed promotion parameters for the first selected node, and said generating includes generating the forecast of a promotion lift for the first selected node based upon the proposed promotion parameter.

12. The method of claim 11, further comprising:
obtaining an actual promotion lift during a promotion implemented at the first selected node according to the proposed promotion parameter;
comparing the forecast of the promotion lift and the actual promotion lift; and
receiving an update of the proposed promotion parameters based upon said comparing.

13. The method of claim 11, wherein the proposed promotion parameter includes at least one parameter of a new proposed promotion plan, or at least one parameter for changing an existing promotion plan.

14. The method of claim 11, further comprising, upon request, processing the proposed promotion parameter based on a permission level of a user submitting the proposed promotion parameter.

15. The method of claim 14, wherein said processing includes:
upon determining that the user has a permission of approval, changing the existing promotion plan based upon the proposed promotion parameter or storing the new proposed promotion plan as approved;
upon determining that the user has a permission of proposing, sending the proposed promotion parameters to another user that has the permission of approval; or
upon determining that the user has a permission of promotion window change and the proposed promotion parameter includes a change of a time window of the existing promotion plan, updating only the time window of the existing promotion plan based upon the proposed promotion parameter.

16. The method of claim 1, wherein the input parameter includes starting and ending inventories of the product at the first selected node of one or more days, and said generating includes generating the forecast of days-on-hand at the first selected node based upon the input parameter.

17. The method of claim 16, wherein said generating includes generating, based upon the forecast of the days-on-hand, a forecast of a production plan at a plant manufacturing the product, a forecast of a stock allocation from the plant to at least one manufacturer DC, or a combination thereof.

18. The method of claim 1, further comprising sending the forecast, data associated with at least the first selected node, and data associated with at least another node of the nodes that is either upstream or downstream relative to the first selected node, to a client-side computer for presentation via a graphical user interface.

19. A system for web-based management of consumer packaged goods (CPG) at a plurality of nodes of supplying a product, the product being a type of the CPG, the system comprising:
one or more server computers; and
one or more memory devices having one or more programs stored thereon for instructing said server computers to:
receive:
at least one input parameter, the input parameter being associated with a first selected node of the nodes; and
a request to generate a forecast for at least one output parameter based upon the input parameter; and
generate the forecast based upon a database storing data of the nodes and based upon implementing a model with the data and the input parameter.

20. The system of claim 19, wherein said server computers include:
one or more web servers configured to receive the request and the input parameter; and
one or more working servers configured to generate the forecast for presentation via an app on a client-side computer.
